(19) United States
(12) Patent Application Publication
(10) Pub. No.: US 2025/0031150 A1
(43) Pub. Date: Jan. 23, 2025

(54) Node, Wireless Device, and Methods Performed Thereby, for Handling Signals

(71) Applicant: Telefonaktiebolaget LM Ericsson (publ), Stockholm (SE)

(72) Inventors: Andreas Höglund, Solna (SE); Emre Yavuz, Stockholm (SE); Saeedeh Moloudi, Linköping (SE); Zhilan Xiong, Solna (SE)

(21) Appl. No.: 18/712,998

(22) PCT Filed: Nov. 25, 2022
(86) PCT No.: PCT/SE2022/051101

§ 371 Date: May 23, 2024

Related U.S. Application Data
(60) Provisional application No. 63/264,588, filed on Nov. 26, 2021.

(51) Int. Cl. H04W 52/02; H04L 5/00; H04W 72/0446

(52) U.S. Cl. CPC H04W 52/0235; H04L 5/0005; H04W 72/0446

(57) ABSTRACT

A method by a node (101), for handling signals. The node (101) operates in a wireless communications network (100). The node (101) determines (502) a distribution of one or more wireless devices (130) served by the node (101) into a plurality of groups. The determining (502) is based on a division of resources available to the node (101) into a corresponding plurality of groups. The resources comprise at least one of: code resources, frequency resources and time resources. The determined plurality of groups determines a corresponding plurality of sets of one or more signals to wake-up the one or more wireless devices (130), to be respectively monitored by the one or more wireless devices (130). The node (101) then initiates (504) transmitting the corresponding plurality of sets of one or more signals to wake-up the one or more wireless devices (130), based on the determined distribution to at least one of the wireless devices (130).

### TECHNICAL FIELD

The present disclosure relates generally to a node, and methods performed thereby, for handling signals. The present disclosure also relates generally to a wireless device and methods performed thereby for handling the signals.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points. The expression Uplink (UL) may be used for the transmission path in the opposite direction i.e., from the wireless device to the base station.

The Fifth Generation (5G) Packet Core Network may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit may be understood to be lower energy consumption and longer device battery life, or at a fixed energy consumption, the downlink latency may be reduced, shorter Discontinued Reception (DRX)/duty-cycles, and more frequent checks for incoming transmissions.

FIG. 1 is a schematic diagram illustrating location of a WUS and the paging occasion to which it is associated. In FIG. 1, white blocks indicate possible WUS, and PO positions, whereas the black boxes indicate actual WUS and PO positions.

### WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated very many times and the WUS may be relatively much shorter and hence may require less reception time for the UE. The logic may be understood to be that a UE may check for a WUS a certain time before its PO, and only if a WUS is detected, the UE may continue to check for PDCCH in the PO, and if not, which is most of the time, the UE may go back to a sleep state to conserve energy. Due to the coverage enhancements, the WUS may be of variable length depending on the coverage of the UE, see FIG. 2.

FIG. 2 is a schematic diagram illustrating WUS for NB-IoT and LTE-M. As depicted in in FIG. 2, where the horizontal axis represents time, the WUS may have a duration, which may be a fraction of a configured maximum WUS duration. Between the end of the configured maximum WUS duration and the beginning of the associated paging occasion (PO) there may be a gap. A gap may be understood as a time offset between the WUS monitoring occasion and the paging occasion. A gap may also be referred to as an offset.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS would be transmitted only when there may be paging for the UE. But if there is no paging for the UE, then the WUS may be understood to not be transmitted, implying a discontinuous transmission (DTX) and the UE may go back to sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and WUS gap capability, that is, the minimum time required for the UE to start up its main receiver see below. Further WUS information was added in the specification to the paging message/request from Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE may support WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, many, POs. An eNB may configure one WUS gap for UEs using DRX, and another one for UEs using eDRX, see e.g., TS 36.331, version 16.6.0, examples are given for NB-IoT, LTE-M is similar:

WUS-Config-NB information element

| WUS-Config-NB-r15 ::= | SEQUENCE { | |
|---|---|---|
| maxDurationFactor-r15 | WUS-MaxDurationFactor-NB-r15, | |
| numPOs-r15 | ENUMERATED {n1, n2, n4} | DEFAULT n1, |

| | |
|---|---|
| numDRX-CyclesRelaxed-r15 | ENUMERATED {n1, n2, n4, n8}, |
| timeOffsetDRX-r15 | ENUMERATED {ms40, ms80, ms160, |

ms240},

| | |
|---|---|
| timeOffset-eDRX-Short-r15 | ENUMERATED {ms40, ms80, ms160, |

ms240},

| | |
|---|---|
| timeOffset-eDRX-Long-r15 | ENUMERATED {ms1000, ms2000} |

```
  OPTIONAL, -- Need OP
  ...
}
```

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, |
| one64th, one32th, one16th, | |
| | oneEighth, oneQuarter, |

oneHalf}

WUS-Config-NB field descriptions

timeOffsetDRX
When DRX is used, non-zero gap from the end of the configured maximum WUS duration to the
associated PO, see TS 36.304 [4], clause 7.4 and TS 36.211 [21]. In milliseconds. Value ms40
corresponds to 40 ms, value ms80 corresponds to 80 ms and so on.
timeOffset-eDRX-Short
When eDRX is used, the short non-zero gap from the end of the configured maximum WUS duration to
the associated PO, see TS 36.304 [4], clause 7.4 and TS 36.211 [21]. In milliseconds. Value ms40
corresponds to 40 ms, value ms80 corresponds to 80 ms and so on.
E-UTRAN configures timeOffset-eDRX-Short to a value longer than or equal to timeOffsetDRX.
timeOffset-eDRX-Long
When eDRX is used, the long non-zero gap from the end of the configured maximum WUS duration to
the associated PO, see TS 36.304 [4], clause 7.4 and TS 36.211 [21]. In milliseconds. Value ms1000
corresponds to 1000 ms, value ms2000 corresponds to 2000 ms.

The UE capabilities may also indicate the minimum WUS gaps required for the UE to be able to decode PDCCH in the associated PO, for DRX and eDRX, respectively, see TS 36.331, version 16.6.0:

UE-RadioPagingInfo-NB information element

| UE-RadioPagingInfo-NB-r13 ::= | SEQUENCE { | |
|---|---|---|
| ue-Category-NB-r13 | ENUMERATED {nb1} | OPTIONAL, |

...,

| | |
|---|---|
| [[ multiCarrierPaging-r14 | ENUMERATED {true} |

```
  OPTIONAL
  ]],
```

| | | |
|---|---|---|
| [[ | mixedOperationMode-r15 | ENUMERATED {supported} |

OPTIONAL,

| | | |
|---|---|---|
| wakeUpSignal-r15 | ENUMERATED {true} | OPTIONAL, |

| | |
|---|---|
| wakeUpSignalMinGap-eDRX-r15 | ENUMERATED {ms40, ms240, |

ms1000, ms2000} OPTIONAL,

| | |
|---|---|
| multiCarrierPagingTDD-r15 | ENUMERATED {true} |

```
  OPTIONAL
  ]],
```

| | | |
|---|---|---|
| [[ | ue-Category-NB-r16 | ENUMERATED {nb2} |

OPTIONAL,

| | | |
|---|---|---|
| groupWakeUpSignal-r16 | ENUMERATED {true} | OPTIONAL, |

| | |
|---|---|
| groupWakeUpSignalAlternation-r16 | ENUMERATED {true} |

```
  OPTIONAL
  ]]
}
```

wakeUpSignalMinGap-eDRX may be understood to indicate the minimum gap the UE may support between WUS or Group WUS (GWUS) and associated PO in case of eDRX in Frequency Division Duplexing (FDD), as specified in TS 36.304, version 16.5.0. Value ms40 corresponds to 40 ms, value ms240 corresponds to 240 ms and so on. If this field is included, the UE may be required to also indicate support for WUS or GWUS for paging in DRX.

At the end of Rel-15, a longer WUS gap of 1s or 2s was introduced to enable the use of a Wake-Up receiver (WUR), since, starting up the baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1 it is indicated which WUS time gap the UE and the eNB, may be required to apply depending on the reported UE capability.

Paging with Wake Up Signal

Section 7.4 of TS 36.304, version 16.5.0 describes a specification of paging with wake up signal. According to this specification, paging with Wake Up Signal may only be used in the cell in which the UE most recently entered RRC_IDLE triggered by: a) reception of RRCEarlyDataComplete, or b) reception of RRCConnectionRelease not including noLastCellUpdate, or c) reception of RRCConnectionRelease including noLastCellUpdate and the UE was using (G)WUS in this cell prior to this Radio Resource Control (RRC) connection attempt.

If the UE is in RRC_IDLE, the UE may not be using GWUS according to clause 7.5 and the UE supports WUS, and WUS configuration may be provided in system information, the UE may be required to monitor WUS using the WUS parameters provided in System Information. When DRX is used and the UE detects WUS, the UE may be required to monitor the following PO. When extended DRX is used and the UE detects WUS, the UE may be required to monitor the following numPOs POs or until a paging message including the UE's Non-Access Stratum (NAS) identity may be received, whichever may be earlier. If the UE does not detect WUS, the UE may not be required to monitor the following PO(s). If the UE missed a WUS occasion, e.g., due to cell reselection, it may monitor every PO until the start of the next WUS or until the paging time window (PTW) ends, whichever may be earlier. A PTW may be understood as a time window containing one or more paging occasions (POs) which may be required to be monitored by the UE in eDRX operation.
numPOs=Number of consecutive Paging Occasions (PO) mapped to one WUS provided in system information where (numPOs≥1).

The WUS configuration, provided in system information, may include a time-offset between the end of WUS and the start of the first PO of the numPOs POs the UE may be required to monitor. The timeoffset in subframes, used to calculate the start of a subframe g0, see TS 36.213, version 16.7.1, may be defined as follows. For a UE using DRX, it may be the signalled timeoffsetDRX. For a UE using eDRX, it may be the signalled timeoffset-eDRX-Short if timeoffset-eDRX-Long is not broadcasted. And for a UE using eDRX, it may be the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms | timeoffset-eDRX-Short | timeoffset-eDRX-Short |
| wakeUpSignalMinGap-eDRX | or not | | |
| | reported | | |
| | 240 ms | timeoffset-eDRX-Short | timeoffset-eDRX-Short |
| | 1000 ms | timeoffset-eDRX-Long | timeoffset-eDRX-Long |
| | 2000 ms | timeoffset-eDRX-Short | timeoffset-eDRX-Long |

The timeoffset may be used to determine the actual subframe g0 as follows, taking into consideration resultant System Frame number (SFN) and/or Hyper Frame SFN (H-SFN) wrap-around of this computation: g0=PO−timeoffset, where PO is the Paging Occasion subframe as defined in clause 7.1.

For a UE using eDRX, the same timeoffset may apply between the end of WUS and associated first PO of the numPOs POs for all the WUS occurrences for a PTW.

The timeoffset, g0, may be used to calculate the start of the WUS as defined in TS 36.213, version 16.7.1.

In essence, the UE may only use WUR, or timeOffset-eDRX-Long, if it may be capable of starting up the main receiver as quickly as indicated by the value used in SI. If not, it may fall back to using timeOffset-eDRX-Short, without WUR.

Since UEs may share PO, the eNB may, in worst case, have to transmit up to 3 WUSs for one PO, for example, corresponding to timeoffsetDRX, timeoffset-eDRX-Short, and timeoffset-eDRX-Long.

FIG. 3 is a schematic diagram illustrating the use of eDRX and DRX WUS gaps for NB-IoT and LTE-M. In the non-limiting example depicted in FIG. 3, a first WUS is transmitted having a timeoffset-eDRX-Long between its transmission and that of the PDCCH in the PO. A second WUS is transmitted having a shorter, timeoffsetDRX, between the transmission of the second WUS and that of the PDCCH in the PO. After the PDCCH, the PDSCH may be transmitted.

### WUS UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO). The objective was to specify the following set of improvements for machine-type communications for BL/CE UEs: Improved DL transmission efficiency and/or UE power consumption. Particularly, to specify support for UE-group wake-up signal (WUS) [RAN1, RAN2, RAN4].

The purpose may be understood to be to reduce the false paging rate, that is, to avoid that that a given UE may be unnecessarily woken up by a WUS transmission intended for another UE. This feature may be referred to as Rel-16 group WUS, or GWUS.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was that for the small fraction of UEs in bad coverage and with large synchronization error due to the use of longer DRX cycles. The gain for such UEs was that with the use of PEI they would typically only have to acquire one Synchronisation Signal Block (SSB) before decoding PEI, instead of up to 3 SSBs if PEI was not used, value according to UE vendors. Accordingly, for most UEs, Rel-17 PEI may not result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen in from the next subsection, making it much less interesting for WUR, since the main baseband receiver may be understood to be required for decoding PEI. That is, the main baseband received may be understood to not be able to be in sleep state, and therefore there may be no WUR gains.

### Rel-18 NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO, to allow the UE to start up the main receiver. Therefore, the main difference to Rel-17 PEI may be understood to be that the WUS in Rel-18 should not be PDCCH-based and allow for a simpler and low power receiver, that is, WUR, e.g., using On-Off Keying (OOK), modulation, and non-coherent detection.

In a Rel-18 preparatory email discussion, the moderator's summary for WUR was the following [RP-211664]. A first proposal, Proposal 1 (non-controversial) was, for UE power savings, to focus further RAN discussions on enhancements based on ultra-low power UE receiver and wake up signal, including whether the enhancement may target general purpose use cases or may target specific use cases such as REDCAP, XR. If included as part of Rel-18, relevant work may need to start with a study item to verify the benefits, feasibility, and applicable scenarios. The following was provided as a starting point for further discussions in determining the relevant work scope on UE power savings: a) performance evaluation UE power savings based on ultra-low power UE receiver and wake up signal (RAN1), b) hardware feasibility evaluation (RAN4), c) design of wake up signal for ultra-low power UE receiver (RAN1), and d) relevant procedures (RAN1, RAN2).

However, the WUR was also discussed in the parallel thread on Rel-18 eRedCap and here the conclusions were the following [RP-212221].

The applicability of WUS/WUR was discussed. The common desire was that a specified solution should be usable by all types of UEs, but not limited to RedCap UEs. It was also clarified that the prime targeted use case for this study should be RedCap, i.e., low-end IoT use cases. Studies and normative work on low-power receivers targeting Enhanced Mobile Broadband (eMBB), i.e., smart phone use cases, had been conducted in Rel-16 and Rel-17. Clarification on the relation of the WUS/WUR study to previous work on UE Power Saving was requested. According to the moderators, understanding, previous RAN work was based on existing NR signals, whereas this System Information (SI) is supposed to also look into potentially new signals.

For the so called RedCap evolution, the main goal was to further embrace new use cases, especially requiring low-cost devices and low energy consumption, and particularly, to study low power wake-up receiver/wake-up signal (WUR/WUS). The study was set to target ultra-low power WUS/WUR required by RedCap use cases. The specified solutions were to not be limited to RedCap UEs only. As opposed to the work on UE power savings in previous releases, this study was set to not require existing signals to be used as WUS. Solutions were requested to give justifiable gains compared to the existing Rel-16/17 UE power saving enhancements.

The objectives set were to: a) study use cases, evaluation methodology & Key Performance Indicators (KPIs), and compatibility with other UE power saving solutions, b) study and evaluate low-power wake-up receiver architectures, c) study and evaluate wake-up signal designs to support wake-up receivers, d) study and evaluate protocol changes needed to support wake-up receivers, e) study potential system impact, such as network and other UE's power consumption, coexistence with R17 RedCap and non-RedCap UEs, network coverage.

The power saving/energy efficiency enhancements that were set were enhanced DRX in RRC_INACTIVE (>10.24s), if not completed in R17, and to identify use cases and study corresponding protocol enhancements to support operation on intermittently available energy harvested from the environment. It was noted that how the devices harvest and store energy is outside the scope of 3GPP

That is, it remains to be seen if WUR will be introduced as a RedCap-specific feature under the RedCap Work Item (WI), or as a general NR feature in a separate WI.

For more details on e.g., suggestions on WUR architecture and design, receiver power vs. sensitivity trade-off see e.g., RP-212005, RP-212254, RP-212367, and RP-212427 which were submitted to RAN3 #93-e.

The benefit of WUR may be understood to be to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ˜3 uW, that this may even, in combination with energy harvesting, enable that the WUR may be continuously on, that is, DRX or duty-cycling may be not used.

### IEEE WUR

In IEEE, the support for WUR has been specified to a greater extent than in 3GPP. That is, the focus was on low power WUR from the start, and the design may use WUR not only for receiving the WUS but also other control signals and signaling, such as synchronization and mobility information. This may be understood to allow the stations, corresponding to UEs in 3GPP, to only use the WUR when there may be no user-plane data transmission ongoing.

Similar to the 3GPP solution, the use of WUR may only be enabled in stations and not in access points (APs), that is, for downlink communication only. The AP may advertise that it has WUR operation capability, along with WUR configuration parameters, among other info, in which band/channel WUR may be operational, which may be different from the band/channel used for data transmission using the main receiver, e.g., WUR in 2.4 GHz band but data communication in 5 GHz band. Also, it may be noted that the WUR operating channel may be advertised in the legacy beacon, and that the WUR discovery operating channel may be different from the WUR operating channel. Stations may then request to be configured with WUR mode of operation. This request may have to be granted by the AP, and in case it is granted, the station may be further configured/setup for WUR mode of operation, that is, the configuration may be only valid for the connection to the associated AP, and further, the configuration may have to be torn down/de-configured if WUR is not to be used anymore. Both continuous WUR, that is, the receiver open all the time, and duty-cycled WUR, that is, receiver only open during preconfigured time slots, mode of operations may be supported. For the latter, the length of the duty-cycles and on-time during wake up may be part of the WUR configuration.

Unlike the 3GPP solution, the WUR operation mode may be understood to be a “sub-state” of the regular operation and upon the detection of a WUS transmission from the AP, the station may resume the power saving mechanism it may have been configured with before entering the WUR operation mode. That is, IEEE has specified a number of different power saving mechanisms, and for example if duty-cycled monitoring of the downlink has been configured for the station, it may switch to that upon detection of the WUS, unlike the specified 3GPP mechanism which may only cover paging, and the UE may continue to monitor PDCCH if WUS is detected. In this way, the IEEE WUR functionality may be understood to be more general, and may still allow for the station to, upon detection of WUS, “monitor paging” by checking in the beacon from the AP for which stations there is data, or for the station to directly respond with an uplink transmission.

The IEEE WUS does not contain any information for synchronization, and the station may instead have to sync using legacy procedure, that is, using sync info in the beacon from the AP, typically transmitted every 100 ms, or from the transmission to another station. Synchronization to the wireless medium may be understood to refer to the following in IEEE 802.11; a station changing from sleep to awake in order to transmit may have to perform channel clear assessment until it may receive one or more frames that may allow it to correctly set the virtual carrier sensing. This may be understood to be to prevent collisions with transmissions from hidden nodes. In short, the virtual carrier sensing may tell a station to defer for a time period even if the wireless medium may appear to be idle, and may be set by receiving frames that may indicate the duration of an ongoing frame exchange. It may be noted that WiFi is a high Signal to Noise Ratio (SNR) technology and typically, one beacon transmission may be enough to sync for the station, that is, no need to acquire several transmission due to poor coverage. Unlike operation in licensed bands, the station may also have to apply carrier sensing, and also possibly re-acquire channel sensing parameters, before uplink transmission.

The physical wake-up signal (WUS) in IEEE may contain complete frames which may have to be processed by the station. The drawback with this design may be understood to be that it may require more processing and handling and processing in the station, that is, compared to a simple WUR design, which may trigger one pre-defined activity in case WUS may be detected. The benefit may be that it may contain more information and the solution may be more general. The IEEE WUS may contain information to indicate if the WUS may be a WUR sync beacon, see below, a WUR discovery beacon, see below, or a regular WUS, intended to wake the station up. The WUS may also contain proprietary frames, which may e.g., be used to directly turn actuators on/off. The transmission may use on/off keying (OOK) modulation, using Manchester coding, but may be using multi-carrier OOK which may be generated by an Orthogonal Frequency Division Multiplexing (OFDM) transmitter, that is, WUR may be enabled as a software upgrade in APs. The WUS may be 4 MHz wide, but a whole 20 MHz channel may be reserved. The WUS may start with a 20 MHz legacy preamble, to allow other stations to perform carrier sense, followed by 4 MHz Manchester coded OOK. Two data rates may be supported: 62.5 kilo bits per second (kbps) and 250 kbps, and link adaptation may be up to the AP, each packet may be self-contained and include the data rate, that is, in the WUR there may be two possible sync words used to signal the data rate.

The WUS may contain the following information: a) Station Identifier (ID), or group ID, grouping of stations may be supported, b) payload up to 22 bytes, c) short frames may contain only basic information; which WUR frame type+addressing, d) ordinary frames may contain control information, and in addition proprietary information, e) WUR beacons may contain Basic Service Set Identifier (BSS-ID), 12 bits compressed, sync information, time counter, f) similar structure for WUS and WUR beacons, sync words may indicate the data rate, the station may then detect the header, from this, the station may tell if it is WUS or beacon, then check body, and g) WUR discovery frames may contain mobility related information to allow for lower power scan, see below.

Regarding mobility, both WUR sync beacons and WUR discovery beacons have been specified, which may only require the WUR to be used for reception, such that stations may stay in the WUR operation mode unless there is data transmission for the station. That is, stations may only need to switch back to legacy Power Saving Mode (PSM) upon WUS detection, or when moving to a new AP. WUR sync beacons may be used by stations to obtain rough synchronization, for data transmission the legacy beacon may be required to still be acquired, and WUR discovery beacons may be used to carry (legacy) mobility information to enable quick/low energy scanning, allowing stations, only using the WUR, to get information related to local and roaming scans for nearby APs, e.g., Service Set Identity (SSID) and main radio operating channels, if the channel quality should deteriorate.

That is, in the WUR discovery beacon, the AP may indicate one or more Basic Service Set (BSS), and the BSS-ID may have a one-to-one mapping with the assigned SSID name, in which WUR may be supported such that stations may not have to scan all frequencies/channels. Since the WUR discovery beacon may contain the legacy mobility information, there may be some duplication/redundancy in the broadcasted information. This may allow for low power scanning, using only the WUR. Note however that mobility in IEEE may be restricted to the same AP, and that hand-over between APs etc. may not be supported in the same way as in 3GPP. If a station in WUR operation mode moves to a new AP, it may have to move out of WUR operation mode and use the main receiver to obtain the beacon, sync, configuration, and associate to the new AP.

In spite of the benefits of wake-up signals, existing methods to wake-up wireless devices may result in a waste of network resources, as well as energy resources.

### SUMMARY

As part of the development of embodiments herein, one or more challenges with the existing technology will first be identified and discussed.

As described in the introduction, a long enough WUS gap to allow the implementation of WUR was introduced in Rel-15 for NB-IoT and LTE-M. This may be understood to be limited to duty-cycled monitoring of paging, e.g., using DRX. WUR however may be understood to enable continuous monitoring of paging, that is, the network may reach the UE at any point in time. This may be understood to require substantial changes in 3GPP to work.

In some examples, ‘continuous WUR’ mode of operation may be enabled in cellular networks through methods on how to adapt the paging procedure.

With legacy paging procedure, a UE may monitor paging in certain paging frames (PF) and paging occasion (PO), see definition in TS 38.304, v. 16.6.0. In this legacy procedure, UEs may be spread uniformly over different PFs and POs, and different paging narrowbands for LTE-M, or paging carriers for NB-IoT, see TS 36.304, 16.5.0. This may be understood to be a means to increase the paging capacity, for example, if all UEs wake up to monitor for paging at the same time, they cannot all be paged due to a physical transmission limitation. They cannot all be paged in the same paging message due to a size constraint related to a certain maximum number of paging records being included in the paging message. Also, they cannot all be paged to reduce the so called ‘false paging’, that is, that the UE is incorrectly be “woken up” to read the paging message when in fact another UE is paged.

With ‘continuous WUR’, paging capacity may be understood to be less of an issue. This may be understood to be since, compared to legacy procedure, any time slot may be used for paging. The ‘false paging’ issue may however be much worse if all the one or more wireless devices 130 are monitoring WUS and paging continuously in time. This may require UE paging/WUS grouping which may be achieved by any, or any combination, of the methods that will be described herein.

It is an object of embodiments herein to improve handling signals, such as Wake-Up Signals, (WUSs).

According to a first aspect of embodiments herein, the object is achieved by a method, performed by a node. The method is being for handling signals. The node operates in a wireless communications network. The node determines a distribution of one or more wireless devices served by the node into a plurality of groups. The determining is based on a division of resources available to the node into a corresponding plurality of groups. The resources comprise at least one of: code resources, frequency resources and time resources. The determined plurality of groups determines a corresponding plurality of sets of one or more signals. The one or more signals are to wake-up the one or more wireless devices. The corresponding plurality of sets of one or more signals are to be respectively monitored by the one or more wireless devices. The node then initiates transmitting the corresponding plurality of sets of one or more signals to wake-up the one or more wireless devices, based on the determined distribution, to at least one of the wireless devices.

According to a second aspect of embodiments herein, the object is achieved by a method, performed by a wireless device. The method is for handling the signals. The wireless device operates in the wireless communications network. The wireless device determines a respective group to which the wireless device belongs. The respective group is based on the distribution of one or more wireless devices served by the node operating in the wireless communications network into the plurality of groups. The distribution is based on the division of resources available to the node into the corresponding plurality of groups The resources comprise at least one of: code resources, frequency resources and time resources. The determined plurality of groups determines the corresponding plurality of sets of one or more signals to wake-up the one or more wireless devices. The corresponding plurality of sets of one or more signals are to be respectively monitored by the one or more wireless devices. The wireless device then receives the corresponding set of one or more signals to wake-up the wireless device, based on the determined respective group.

According to a third aspect of embodiments herein, the object is achieved by the node, for handling the signals. The node is configured to operate in the wireless communications network. The node is further configured to determine the distribution of the one or more wireless devices configured to be served by the node into the plurality of groups. The determining is configured to be based on the division of resources configured to be available to the node into the corresponding plurality of groups. The resources are configured to comprise the at least one of: the code resources, the frequency resources and the time resources. The determined plurality of groups is configured to determine the corresponding plurality of sets of one or more signals to wake-up the one or more wireless devices. The corresponding plurality of sets of one or more signals are to be respectively monitored by the one or more wireless devices. The node is also configured to initiate transmitting the corresponding plurality of sets of one or more signals to wake-up the one or more wireless devices, based on the distribution configured to be determined, to at least one of the wireless devices.

According to a fourth aspect of embodiments herein, the object is achieved by the wireless device, for handling the signals. The wireless device is configured to operate in the wireless communications network. The wireless device is further configured to determine the respective group to which the wireless device belongs. The respective group is configured to be based on the distribution of the one or more wireless devices configured to be served by the node configured to operate in the wireless communications network into the plurality of groups. The distribution is configured to be based on the division of resources available to the node into the corresponding plurality of groups. The resources are configured to comprise the at least one of: the code resources, the frequency resources and the time resources. The determined plurality of groups is configured to determine the corresponding plurality of sets of one or more signals to wake-up the one or more wireless devices. The corresponding plurality of sets of one or more signals are to be respectively monitored by the one or more wireless devices. The wireless device is also configured to receive the corresponding set of one or more signals to wake-up the wireless device, based on the respective group configured to be determined.

By determining the distribution of the one or more wireless devices into the respective groups, the plurality of groups determining the corresponding plurality of sets of one or more signals to wake-up the one or more wireless devices to be respectively monitored by the one or more wireless devices, and then initiating transmitting the corresponding plurality of sets of one or more signals to wake-up the one or more wireless devices based on the determined distribution, the node may enable the one or more wireless devices to monitor the respective set of one or more signals corresponding to their respective group and refrain from monitoring those corresponding to other groups. By distributing the one or more wireless devices into the respective groups, the node may enable to reduce false paging, since the one or more wireless devices may be enabled to avoid being incorrectly “woken up” to read a paging message when in fact another wireless device in another group may be paged. The node may thereby enable the continuous WUR mode of operation in the wireless communications network.

Similarly, by determining the distribution of the one or more wireless devices into the respective groups and then receiving the corresponding set of one or more signals to wake-up the wireless device based on the determined distribution, the wireless device 131 may be enabled to monitor the respective set of one or more signals corresponding to its respective group and refrain from monitoring those corresponding to other groups. The wireless device may therefore be enabled to reduce false paging, since the wireless device may be enabled to avoid being incorrectly “woken up” to read a paging message when in fact another wireless device in another group may be paged. The wireless device may thereby enable the continuous WUR mode of operation in the wireless communications network.

### BRIEF DESCRIPTION OF THE DRAWINGS

Examples of embodiments herein are described in more detail with reference to the accompanying drawings, according to the following description.

FIG. 1 is a schematic diagram depicting an illustration of a location of a WUS and the paging occasion to which it is associated.

FIG. 2 is a schematic diagram depicting an illustration of WUS for NB-IoT and LTE-M.

FIG. 3 is a schematic diagram illustrating the use of eDRX and DRX WUS gaps for NB-IoT and LTE-M.

FIG. 4 is a schematic diagram depicting an example of a wireless communications network, according to embodiments herein.

FIG. 5 is a flowchart depicting a method in a node, according to embodiments herein.

FIG. 6 is a flowchart depicting a method in a wireless device, according to embodiments herein.

FIG. 7 is a schematic illustration depicting: (a) FDM WUS, (b) TDM WUS, and (c) a combination of TDM and FDM WUS, according to examples of embodiments herein.

FIG. 8 is a schematic block diagram illustrating two embodiments, in panel a) and panel b), of a node, according to embodiments herein.

FIG. 9 is a schematic block diagram illustrating two embodiments, in panel a) and panel b), of a wireless device, according to embodiments herein.

FIG. 10 is a schematic block diagram illustrating a telecommunication network connected via an intermediate network to a host computer, according to embodiments herein.

FIG. 11 is a generalized block diagram of a host computer communicating via a base station with a user equipment over a partially wireless connection, according to embodiments herein.

FIG. 12 is a flowchart depicting embodiments of a method in a communications system including a host computer, a base station and a user equipment, according to embodiments herein.

FIG. 13 is a flowchart depicting embodiments of a method in a communications system including a host computer, a base station and a user equipment, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

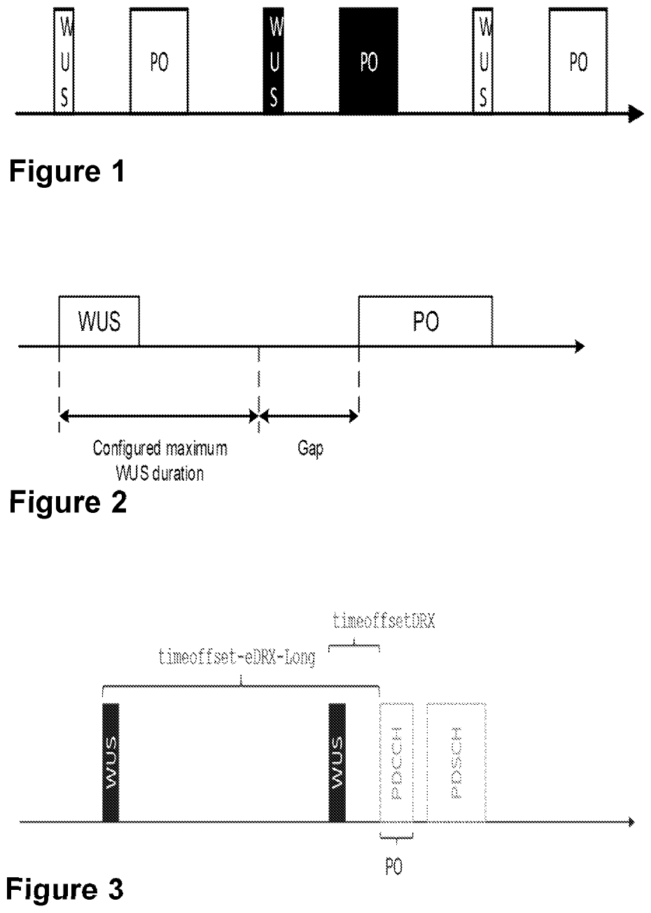

### DETAILED DESCRIPTION

Certain aspects of the present disclosure and their embodiments may provide solutions to the challenges presented in the Summary section or other challenges. Embodiments herein may be generally understood to relate to different aspects of providing adaptations for continuous WUR operation. Embodiments herein may be understood to provide methods for defining UE groups for paging, to reduce the false paging rate and increase paging capacity, for continuous WUR operation.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

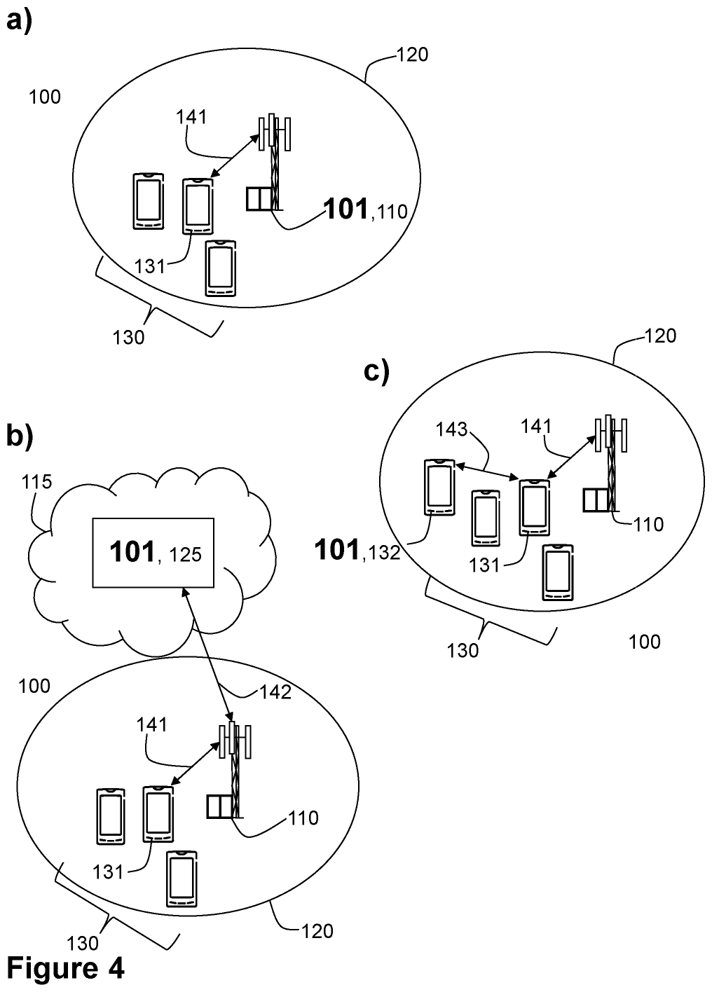

FIG. 4 depicts three non-limiting examples, in panel a), panel b) and panel c), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network, or a younger system with similar functionality. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced LAA (eLAA), further enhanced LAA (feLAA) and/or MulteFire. The wireless communications network 100 may support MTC, enhanced MTC (eMTC), IoT and/or NB-IoT. Yet in other examples, the wireless communications network 100 may instead, or in addition, support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a node 101 is depicted in the non-limiting example of FIG. 4. The node 101 may be any of a network node, such as the network node 110 described below, as e.g., depicted in the non-limiting example of panel a), a core network node, such as the core network node 125 described below, as e.g., depicted in the non-limiting example of panel b), and a wireless device, such as the another wireless device 132 described below, as e.g., depicted in the non-limiting example of panel c).

The wireless communications network 100 may comprise a plurality of network nodes, whereof a network node 110 is depicted in the non-limiting example of FIG. 4. The network node 110 is a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, the network node 110 may be a distributed node, and may partially perform its functions in collaboration with a virtual node in a cloud 115.

The wireless communications network 100 may cover a geographical area, which in some embodiments may be divided into cell areas, wherein each cell area may be served by a radio network node, although, one radio network node may serve one or several cells. In the example of FIG. 4, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the wireless communications network 100 may be directly connected to one or more core networks.

The one or more networks may comprise a plurality of core network nodes, whereof a core network node 125 is depicted in the non-limiting example of panel b) in FIG. 4. The core network node 125 may be capable to communicate with any of the one or more wireless devices 130 described below via, e.g., Non-Access Stratum signalling. For example, the core network node 125 may be an AMF.

A plurality of wireless devices may be located in the wireless communication network 100, whereof one or more wireless devices 130 comprising a wireless device 131 are depicted in the non-limiting example of FIG. 4. The wireless communications network 100 may also comprise another wireless device 132. While the non-limiting examples of FIG. 4 depict the one or more wireless devices 130 as comprising three wireless devices, it may be understood that this is non-limiting and for illustration purposes only. The one or more wireless devices 130 may comprise additional wireless devices. In embodiments wherein the node 101 may be the another wireless device 132, as depicted in panel c) of FIG. 4, the another wireless device 132 may be able to communicate with the one or more wireless devices 130, e.g., directly, via device to device communication. Any of the one or more wireless devices 130, the wireless device 131 and the another wireless device 132 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the one or more wireless devices 130, the wireless device 131 and the another wireless device 132 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the one or more wireless devices 130, the wireless device 131 and the another wireless device 132 comprised in the wireless communications network 100 may be enabled to communicate wirelessly in the wireless communications network 100. The communication may be performed e.g., via a RAN, and possibly the one or more core networks, which may be comprised within the wireless communications network 100, or directly, device to device.

The node 101 may be configured to communicate within the wireless communications network 100 with the wireless device 131 over a first link 141, e.g., a radio link. The network node 110 may be configured to communicate within the wireless communications network 100 with the core network node 125 over a second link 142, e.g., a radio link or a wired link. The wireless device 131 may be configured to communicate within the wireless communications network 100 with the another wireless device 132 over a third link 143, e.g., a radio link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second” and/or “third” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to node, such as the node 101, e.g., a core network node (CNN), a gNB or a 5G UE or a UE, and embodiments related to a wireless device such as the wireless device 131, e.g., a UE.

Some embodiments herein will now be further described with some non-limiting examples.

In the following description, any reference to a/the UE, or simply “UE” may be understood to equally refer to any of the one or more wireless devices 130, e.g., the wireless device 131; any reference to a/the UEs may be understood to equally refer to the one or more wireless devices 130; any reference to a/the gNB, a/the NW and/or a/the network may be understood to equally refer to the node 101; any reference to a/the core network may be understood to equally refer to the core network node 125; any reference to a/the WUS(s) may be understood to equally refer to the one or more signals to wake-up the one or more wireless devices 130; any reference to a/the WUR may be understood to equally refer to a receiver to receive the one or more signals to wake-up the one or more wireless devices 130.

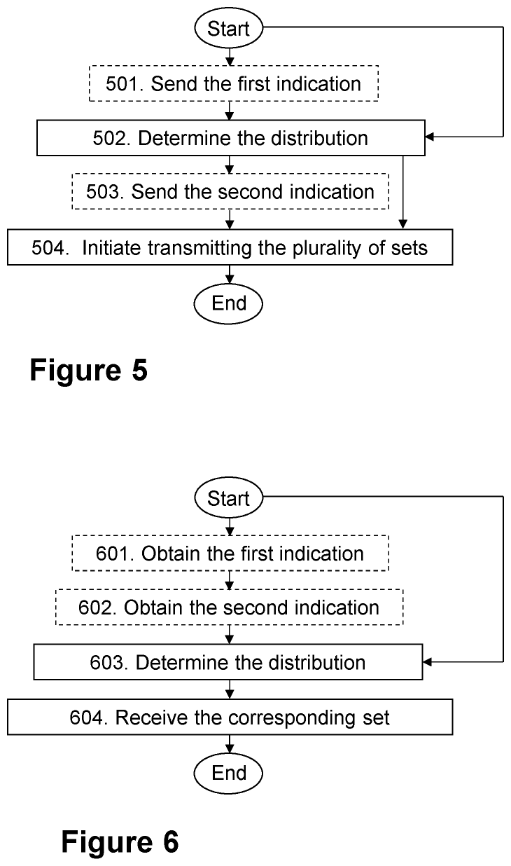

Embodiments of a method performed by a node, such as the node 101 will now be described with reference to the flowchart depicted in FIG. 5. The method may be understood to be for handling signals. The node 101 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The node 101 may be one of: the network node 110, the core network node 125, and the another wireless device 132.

Several embodiments are comprised herein. In some embodiments, all the actions may be performed. In some embodiments, two or more actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 5. Some actions may be performed in a different order than that shown FIG. 5. For example, Action 502 may be performed before Action 501.

In FIG. 5, optional actions in some embodiments may be represented with dashed lines.

### Action 501

In this Action 501, the node 101 may send a first indication.

The sending in this Action 501 may be towards the one or more wireless devices 130. Towards may be understood to mean directly, e.g., from the network node 110, or indirectly, e.g., from the core network node 125.

The one or more wireless devices 130 may operate with continuous WUR.

The first indication may enable the one or more wireless devices 130 to determine a respective group to which they may belong.

The respective group may be based on a distribution of the one or more wireless devices 130 served by the node 101 into a plurality of groups.

The distribution may be based on a division of resources available to the node 101 into a corresponding plurality of groups.

The resources may comprise at least one of: code resources, frequency resources and time resources.

The determined plurality of groups may determine a corresponding plurality of sets of one or more signals to wake-up the one or more wireless devices 130, e.g., WUSs or PEI, to be respectively monitored by the one or more wireless devices 130.

More details about the division of resources and how the respective group may be determined are provided in the description of Action 502, and may be understood to be equally enabled by the first indication.

This Action 501 may be performed, for example, in embodiments wherein the node 101 and the one or more wireless devices 130 may each determine the distribution. The node 101 may send the first indication in this Action 501 to enable the one or more wireless devices 130 to determine the distribution and the node 101 may determine the distribution itself in the next Action 502. The node 101 may then, in Action 503 send a second indication towards the one or more wireless devices 130 indicating a result of that determination.

It may be understood that the first indication may correspond to the description provided later for the second indication in Action 503, only that the first indication may be understood to be sent, e.g., before the determination by the node 101. For example, the first indication may be the WUR frequency resources, as provided by the by the network node 110 as node 101, or a WUR group ID provided by the core network node 125 as node 101. The full description of what the first indication may entail may be facilitated by describing first how the distribution is determined, in Action 502. Any description otherwise provided later in relation to the second indication may be understood to equally apply to the first indication.

The sending in this Action 501 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.

By the node 101 sending the first indication towards the one or more wireless devices 130 in this Action 501, the node 101 may enable the one or more wireless devices 130 to know which respective group they may belong to, and therefore, which WUR resources they may need to monitor in order to receive the one or more signals to wake-up the one or more wireless devices 130. By distributing the one or more wireless devices 130 into the respective groups, the node 101 may enable to reduce false paging, since the one or more wireless devices 130 may be enabled to avoid being incorrectly “woken up” to read a paging message when in fact another wireless device in another group may be paged. The node 101 may thereby enable the continuous WUR mode of operation in the wireless communications network 100.

### Action 502

In this Action 502, the node 101 determines the distribution.

The distribution is of the one or more wireless devices 130. The distribution is into the plurality of groups. The one or more wireless devices 130 are served by the node 101.

The determining in this Action 502 is based on the division of resources into the corresponding plurality of groups. The resources are available to the node 101.

The resources comprise the at least one of: the code resources, the frequency resources and the time resources.

The plurality of groups determine the corresponding plurality of sets of one or more signals. The one or more signals are to wake-up the one or more wireless devices 130. The one or more signals may be, e.g., Wake-Up Signals, WUSs, PEI, or equivalent.

The one or more signals are to be respectively monitored by the one or more wireless devices 130.

Determining in this Action 502 may comprise deciding, deriving or calculating autonomously, receiving from another node, or retrieving from a memory.

### Frequency Division Multiplexing (FDM)

In some embodiments, the division may comprise a first division of frequency resources. For example, the first division may be FDM. That is, resources may be divided in frequency domain, and the one or more wireless devices 130 may be distributed over these groups. Each of the one or more wireless devices 130 may belong to one group, and may then monitor WUS in that frequency resource, which may be defined in terms of Physical Resource Blocks (PRBs), Control Resource Sets (CORESETs), Downlink (DL) Bandwidth Parts (BWPs), subcarriers, etc. Some benefits of having FDM for the WUR monitoring, see below.

In one example, the same number of WUR frequency resources may be configured as the number of groups of the one or more wireless devices 130 supported.

In some of such embodiments wherein the division may comprise the first division of frequency resources, the determining in this Action 502 may be based on the following formula:

WURfrequencyResourceIndex=UE_ID mod N
wherein N may be understood to be a number of groups in the plurality of groups, e.g., the number of WUR UE groups;
WURfrequencyResourceIndex may be understood to be a configuration index of the frequency resources, e.g., the configuration index of the WUR resources in frequency domain, ranging from 0 to N−1, and
UE_ID may be understood to be a respective identity of a respective wireless device, e.g., the wireless device 131. For example, the UE_ID may be understood to be the UE identity based on using a certain number of significant bits of the 5-Serving Temporary Mobile Subscriber Identity (S-TMSI) or S-TMSI, see TS 38.304, v. 16.6.0 or TS 36.304, 16.5.0, respectively.

The one or more wireless devices 130 may then be assigned to a WUR frequency resource based on the expression WURfrequencyResourceIndex=UE_ID mod N.

In other embodiments wherein the division may comprise the first division of frequency resources, every group of the plurality of groups may correspond to a respective set of frequency resources.

In some embodiments, the respective group for the respective wireless device, e.g., the wireless device 131, may be determined according to the following formula:

UE_group=UE_ID mod N
wherein N may be the number of groups in the plurality of groups, and
UE_ID may be the respective identity of the respective wireless device 131.

That is, in these embodiments, UE_group=UE_ID mod N may be understood to be the expression to determine where the wireless device 131 may need to monitor WUS.

In another alternative, WUR resources in frequency domain may be configured with a combination of WUR groups, for example, the wireless device 131 may be configured with a WUR resource frequency domain and a WUR group in that domain, so that the wireless device 131 may monitor for a wake-up signal that may match with a particular WUR group ID in a particular frequency resource.

### Time Division Multiplexing (TDM)

In some embodiments, the division may comprise a second division of time resources. That is, resources may be divided in time domain, and the one or more wireless devices 130 may be distributed over these groups. Each wireless device may belong to one group, and may monitor WUS in the associated, periodically repeating, frequency resources. In legacy, the PFs and POs may be very sparse in time, e.g., most radio frames may not be used as a PF for any wireless device, and most slots may not be used as PO for any wireless device. Embodiments herein may be understood to enable to have the PFs and POs more frequently.

The one or more wireless devices 130 may not be restricted to any PDCCH Search Space, and the wireless device 131 may be assigned to monitor a subset of the WUS candidates in time domain, which unlike for legacy paging procedure, may fill 100% of the downlink physical resources.

In some embodiments, every group of the plurality of groups may correspond to a respective set of time resources. The set of resources may correspond to one of: a radio frame, a subframe, a slot and a symbol.

For the radio frame division, radio frames, e.g., 10 ms long, based on the system frame number (SFN) may be divided into different WUS groups. For example, if a number N UE groups are supported, the wireless device 131 may monitor WUS in the radio frames with SFN, which may fulfil the following equation:

SFN mod(N)=UE_ID mod(N)

In some of such embodiments, the determining in this Action 502 may be based on the following formula: SFN modN=UE_ID modN
wherein N may be the number of groups in the plurality of groups,
SFN may be a System Frame Number, and
UE_ID may be the respective identity of the respective wireless device, e.g., the wireless device 131. The UE_ID may be the same as used in the legacy calculation of PF and PO, e.g., using a certain number of significant bits of the 5-S-TMSI or S-TMSI, see TS 38.304, v. 16.6.0 or TS 36.304, 16.5.0, respectively. The quasi-random nature of the UE_ID, may ensure close to uniform distribution of the WUR one or more wireless devices 130 in the N different groups. A very simple case of the above may be for N=2, in which wireless devices 130 with an odd UE_ID may monitor WUS in radio frames with an odd SFN, and vice versa.

For the subframe level division: Each radio frame may consist of 10 slots of length 1 ms. This may be understood to be for 15 kHz subcarrier spacing, for 30 kHz subcarrier spacing the 10 ms radio frame may be understood to consist of 20 slots of 0.5 ms length, for 60 kHz SCS or 40 slots of 0.25 ms length, etc Different subframes may be configured for different WUR UE groups, or as the starting point. For example, configuring a WUR UE group to be associated with certain subframes, WUR time resources for the wireless device 131 may be determined from the following expression:

UE_group=UE_ID mod N

Accordingly, in other embodiments wherein the division may comprise the second division of time resources, every group of the plurality of groups may correspond to a respective set of time resources. A respective group for the respective wireless device, e.g., the wireless device 131 may be determined according to the following formula:

UE_group=UE_ID mod N
wherein N may be the number of groups in the plurality of groups, and
UE_ID may be the respective identity of the respective wireless device 131.

For the slot level division, the length on a slot may depend on the subcarrier spacing, for 15 kHz Subcarrier Spacing (SCS) 1 subframe=1 slot, for 30 kHz SCS 1 subframe=2 slots, for 60 kHz SCS 1 subframe=4 slots, and so on. Different slots may be configured for different WUR UE groups, or as the starting point. For example, configuring a WUR UE group to be associated with certain slots, WUR time resources for the wireless device 131 may be determined in a similar way to the above.

For the symbol level division, one slot may contain 14 Orthogonal Frequency Division Multiplexing (OFDM) symbols. Different symbols may be configured for different WUR UE groups, or as the starting point. For example, configuring a WUR UE group to be associated with certain symbols, WUR time resources for the wireless device 131 may be determined in a similar way to the above.

In other examples wherein the division may comprise a third division of code resources. In a non-limiting example, a code division multiplexing (CDM), may be also considered for the WUS associated to UE groups.

### Combination of the Above-Mentioned Multiplexing

In some examples the division may be based on a combination of the above-mentioned multiplexing, that is, in an example, resources may be divided both in time and frequency domain, and the one or more wireless devices 130 may be distributed over these groups. Each wireless device of the one or more wireless devices 130 may belong to one group and monitor WUS in the associated time and frequency resource.

The determining in this Action 502 may be based on a respective capability of the one or more wireless devices 130, which may have been obtained by the node 101.

By determining the distribution of the one or more wireless devices 130 into the respective groups in this Action 502, the node 101 may enable to reduce false paging, since the one or more wireless devices 130 may be enabled to avoid being incorrectly “woken up” to read a paging message when in fact another wireless device in another group may be paged. The node 101 may thereby enable the continuous WUR mode of operation in the wireless communications network 100.

### Action 503

In this Action 503, the node 101 may send a second indication.

The sending in this Action 503 may be towards the one or more wireless devices 130. Towards may be understood to mean directly, e.g., from the network node 110, or indirectly, e.g., from the core network node 125.

The second indication may indicate the determined distribution to the at least one of the one or more wireless devices 130.

### Frequency Division Multiplexing (FDM)

In a first example of embodiments wherein the distribution may be based on the division of resources available to the node 101 into the corresponding plurality of groups, and wherein the division may comprise the first division of frequency resources, each WUR frequency resource may be explicitly configured with a WUR UE group ID, or WUR resource ID, e.g., in common Radio Resource Control (RRC) signaling, an example of which is shown below:

| | |
|---|---|
| WurConfig ::= | SEQUENCE { |
| wurConfigCommon | WurConfigCommon |
| wurConfigList | SEQUENCE |

(SIZE(1..nrWusUeGroups)) OF WurFrequencyResourceConfig
OPTIONAL, -- Need N
}

| | |
|---|---|
| WurFrequencyResourceConfig ::= | SEQUENCE { |
| wurUeGroup | INTEGER (0..15), |
| wurFrequencyAllocation | WurFrequencyAllocation, |
| wurConfigSpecific | WurConfigSpecific |

OPTIONAL,
:
}

In an alternative to the above, besides the fact that each group of WUR resources may be explicitly configured with a WUR UE group ID, or WUR resource ID, e.g., in common RRC signaling, the wireless device 131 may be configured with WUR UE group ID, or WUR resource ID, for example, via UE-specific RRC signaling, so that the wireless device 131 may know which WUR resources this wireless device 131 may need to monitor.

In another alternative, as mentioned above, WUR resources in frequency domain may be configured with a combination of WUR groups, for example, the wireless device 131 may be configured with a WUR resource frequency domain and a WUR group in that domain, so that the wireless device 131 may monitor for a wake-up signal that may match with a particular WUR group ID in a particular frequency resource. Regarding the configuration, both the number of WUR frequency resources and the WUR groups may be configured by the radio access network, e.g., by the network node 110 as node 101, via system information broadcast, as stated above. In another alternative, the radio access network, e.g., by the network node 110 as node 101, may configure only the WUR frequency resources, whereas WUR group ID may be provided by the core network, e.g., by the core network node 125 as node 101, via NAS signaling e.g., when the wireless device 131 may perform attach/registration procedure. In this case, the WUR group ID may be provided from the core network, e.g., by the core network node 125 as node 101, to the Radio Access Network (RAN), e.g., the network node 110 as node 101, as part of the paging information container, along with the paging request message. For the latter alternative, the network node 110 as node 101 may broadcast a mapping table to map the WUR group IDs assigned by the core network to IDs configured by the radio access network e.g., by the network node 110 as node 101, if it may be desired to leave it up to radio access network implementation to decide on the number of WUR group IDs required, e.g., WUR group IDs assigned by the core network e.g., by the core network node 125 as node 101, may be mapped to a reduced number of WUR group IDs configured by the radio access network e.g., by the network node 110 as node 101.

In accordance with the foregoing, the sending in any of Action 501 and/or Action 503 may be performed via at least one of: Radio Resource Control (RRC) signalling, System Information (SI) and NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.

### Time Division Multiplexing (TDM)

In an alternative to the above, each group of WUR resource may be explicitly configured with a WUR UE group ID, or WUR resource ID, e.g. in common RRC signaling, the wireless device 131 may be configured with WUR UE group ID, or WUR resource ID, for example, via UE-specific RRC signaling, so that the wireless devices 131 may know which WUR resources this wireless devices 131 may monitor.

By the node 101 sending the second indication towards the one or more wireless devices 130 in this Action 503, the node 101 may enable the one or more wireless devices 130 to know which WUR resources they may need to monitor in order to receive the one or more signals to wake-up the one or more wireless devices 130. By distributing the one or more wireless devices 130 into the respective groups, the node 101 may enable to reduce false paging, since the one or more wireless devices 130 may be enabled to avoid being incorrectly “woken up” to read a paging message when in fact another wireless device in another group may be paged. The node 101 may thereby enable the continuous WUR mode of operation in the wireless communications network 100.

### Action 504

In this Action 504, the node 101 initiates transmitting the corresponding plurality of sets of one or more signals to wake-up the one or more wireless devices 130, e.g., WUSs or PEI.

Transmitting may be, e.g., sending.

Initiating may be understood as triggering, enabling, facilitating or starting. For example, in examples wherein the node 101 may be the core network node 125, the node 101 may enable the network node 110 to perform the transmission, e.g., via the first link 141. In examples wherein the node 101 may be the network node 110 or the another wireless device 132, the node 101 may start performing the transmission, e.g., via the first link 141 or the third link 143, respectively.

The initiating transmitting in this Action 504 of the corresponding plurality of sets of one or more signals to wake-up the one or more wireless devices 130, e.g., WUSs or PEI, is based on the determined distribution. The initiating transmitting in this Action 504 is to at least one of the wireless devices 130.

As stated earlier, the one or more wireless devices 130 may operate on continuous WUR.

By initiating transmitting the corresponding plurality of sets of one or more signals to wake-up the one or more wireless devices 130 based on the determined distribution in this Action 504, the node 101 may enable the one or more wireless devices to monitor the respective set of one or more signals corresponding to their respective group and refrain from monitoring those corresponding to other groups. By distributing the one or more wireless devices 130 into the respective groups, the node 101 may enable to reduce false paging, since the one or more wireless devices 130 may be enabled to avoid being incorrectly “woken up” to read a paging message when in fact another wireless device in another group may be paged. The node 101 may thereby enable the continuous WUR mode of operation in the wireless communications network 100.

Embodiments of a method, performed by a wireless device, such as the wireless device 131, will now be described with reference to the flowchart depicted in FIG. 6. The method may be understood to be for handling the signals. The wireless device 131 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

Several embodiments are comprised herein. The method may comprise two or more of the following actions. In some embodiments, all the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 6. In FIG. 6, optional actions in some embodiments may be represented with dashed lines.

The detailed description of some of the following corresponds to the same references provided above, in relation to the actions described for the node 101 and will thus not be repeated here to simplify the description. For example, the one or more signals to wake-up the one or more wireless devices 130 may be, e.g., Wake-Up Signals, WUSs, PEI, or equivalent.

### Action 601

In this Action 601, the wireless device 131 may obtain the first indication.

The wireless device 131 may operate with continuous WUR.

Obtaining may be receiving from another node, or retrieving from a memory.

In some embodiments, the obtaining, e.g., receiving, in this Action 601 may be from the node 101. This may be directly, e.g., from the network node 110 or the another wireless device 132, or indirectly, e.g., from the core network node 125.

The first indication may enable the wireless device 131 to determine the respective group to which the wireless device 131 may belong.

The respective group may be based on the distribution of the one or more wireless devices 130 into the plurality of groups. The one or more wireless devices 130 may be served by the node 101 operating in the wireless communications network 100.

The distribution may be based on the division of resources available to the node 101 into the corresponding plurality of groups.

The resources may comprise at least one of: code resources, frequency resources and time resources.

The plurality of groups may determine the corresponding plurality of sets of the one or more signals to wake-up the one or more wireless devices 130, e.g., WUSs or PEI, to be respectively monitored by the one or more wireless devices 130.

### Action 602

In this Action 602, the wireless device 131 may obtain the second indication.

Obtaining may be receiving from another node, or retrieving from a memory.

In some embodiments, the obtaining in this Action 602 may be from the node 101, directly, e.g., from the network node 110, or indirectly, e.g., from the core network node 125.

The second indication may indicate the distribution. That is, the distribution as determined by the node 101 in Action 502.

The obtaining in any of Action 601 and/or Action 602 may be performed via at least one of: Radio Resource Control (RRC) signalling, System Information (SI) and NAS signalling. The obtaining via RRC or SI may be performed in examples wherein the node 101 may be the network node 110. The obtaining via NAS signalling may be performed in examples wherein the node 101 may be the core network node 125. In other examples, wherein the node 101 may be the another wireless device 132, the obtaining in any of Action 601 and/or Action 602 may be performed via a SL, e.g., D2D communication.

### Action 603

In this Action 603, the wireless device 131 determines the respective group.

The respective group is to which the wireless device 131 belongs.

The respective group is based on the distribution of the one or more wireless devices 130. The one or more wireless devices 130 are served by the node 101 operating in the wireless communications network 100.

The distribution is into the plurality of groups.

The distribution is based on the division of resources available to the node 101.

The division of resources is into the corresponding plurality of groups.

The resources comprise the at least one of: the code resources, the frequency resources and the time resources.

The determined plurality of groups determines the corresponding plurality of sets of one or more signals. The one or more signals are to wake-up the one or more wireless devices 130.

The one or more signals are to be respectively monitored by the one or more wireless devices 130.

The node 101 may be one of: the network node 110, the core network node 125, and the another wireless device 132.

Determining in this Action 603 may comprise deciding, deriving or calculating autonomously, receiving from another node, or retrieving from a memory.

In some embodiments, the determining in this Action 603 may be based on the obtained second indication. In some embodiments, the determining in this Action 603 may be based on the obtained first indication.

In some embodiments, the determining in Action 603 may be based on the obtained first indication.

In some embodiments, the division may comprise the first division of frequency resources, e.g., FDM. In some of such embodiments, the determining in this Action 603 may be based on the following formula:

WURfrequencyResourceIndex=UE_ID mod N
wherein N may be the number of groups in the plurality of groups, WURfrequencyResourceIndex may be the configuration index of the frequency resources, and
UE_ID may be the respective identity of a respective wireless device, e.g., the wireless device 131. Accordingly, the wireless device 131 may use its respective UE-ID to perform the determining of Action 603.

In other embodiments wherein the division may comprise the first division of frequency resources, every group of the plurality of groups may correspond to the respective set of frequency resources. The respective group for the respective wireless device, e.g., the wireless device 131, may be determined according to the following formula:

UE_group=UE_ID mod N
wherein N may be the number of groups in the plurality of groups, and
UE_ID may be the respective identity of the respective wireless device, e.g., the wireless device 131. Accordingly, the wireless device 131 may use its respective UE-ID to perform the determining of Action 603.

In some embodiments, the division may comprise the second division of time resources, e.g., TDM. In some of such embodiments, the determining in this Action 603 may be based on the following formula:

SFN modN=UE_ID modN
wherein N may be the number of groups in the plurality of groups,
SFN may be the System Frame Number, and
UE_ID may be the respective identity of the respective wireless device, e.g., the wireless device 131. Accordingly, the wireless device 131 may use its respective UE-ID to perform the determining of Action 603.

In other embodiments wherein the division may comprise the second division of time resources, every group of the plurality of groups may correspond to the respective set of time resources. A respective group for the respective wireless device, e.g., the wireless device 131 may be determined according to the following formula:

UE_group=UE_ID mod N
wherein N may be the number of groups in the plurality of groups, and
UE_ID may be the respective identity of the respective wireless device 131. Accordingly, the wireless device 131 may use its respective UE-ID to perform the determining of Action 603.

In some embodiments, every group of the plurality of groups may correspond to the respective set of time resources. The set of resources may correspond to one of: a radio frame, a subframe, a slot and a symbol.

The determining in this Action 602 may be based on a respective capability of the wireless device 131, which may have been provided to the node 101.

By determining the distribution of the one or more wireless devices 130 into the respective groups in this Action 603, the wireless device 131 may enable to reduce false paging, since the wireless device 131 may be enabled to avoid being incorrectly “woken up” to read a paging message when in fact another wireless device in another group may be paged. The wireless device 131 may thereby enable the continuous WUR mode of operation in the wireless communications network 100.

### Action 604

In this Action 604, the wireless device 131 receives the corresponding set of one or more signals.

The one or more signals are to wake-up the wireless device 131, based on the determined respective group.

The receiving in this Action 604 may be performed, e.g., via the first link 141, or the third link 143.

By, in this Action 604, receiving the corresponding set of one or more signals to wake-up the wireless device 131 based on the determined distribution in Action 603, the wireless device 131 may be enabled to monitor the respective set of one or more signals corresponding to its respective group and refrain from monitoring those corresponding to other groups. The wireless device 131 may therefore be enabled to reduce false paging, since the wireless device 131 may be enabled to avoid being incorrectly “woken up” to read a paging message when in fact another wireless device in another group may be paged. The wireless device 131 may thereby enable the continuous WUR mode of operation in the wireless communications network 100.

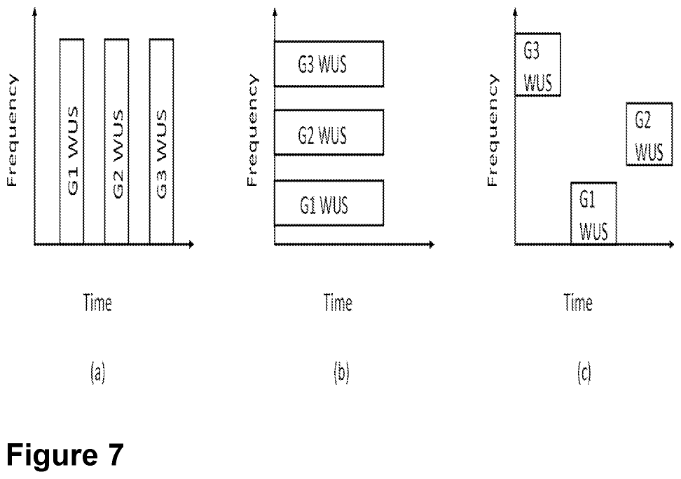

FIG. 7 is a schematic illustration depicting: (a) TDM WUS, (b) FDM WUS, and (c) a combination of TDM and FDM WUS. In FIG. 7, and for illustrative purposes only, it may be appreciated in panel a), the one or more wireless devices 130 are distributed into a plurality of three groups: a first group indicated as G1, a second group indicated as G2 and a third group indicated as G3. The three groups are based on the division of the time resources into a corresponding plurality of three groups G1, G2, G3. In panel b), the one or more wireless devices 130 are also distributed into a plurality of three groups: G1, G2 and G3, but here, the three groups are based on the division of the frequency resources into a corresponding plurality of three groups G1, G2, G3. In panel c), the one or more wireless devices 130 are also distributed into a plurality of three groups: G1, G2 and G3, but here, the three groups are based on a division of a combination of the time and frequency resources into a corresponding plurality of three groups G1, G2, G3. The plurality of groups determines a corresponding plurality of sets of one or more signals to wake-up the one or more wireless devices 130, to be respectively monitored by the one or more wireless devices 130.

In another example, to increase the number of the supported UE groups, CDM on WUS may be considered on top of each resource divisions, e.g., FDM, TDM, or the combination.

Certain embodiments disclosed herein may provide one or more of the following technical advantage(s), which may be summarized as follows. Embodiments herein may be understood to enable a ‘continuous WUR’ mode of operation in cellular networks.

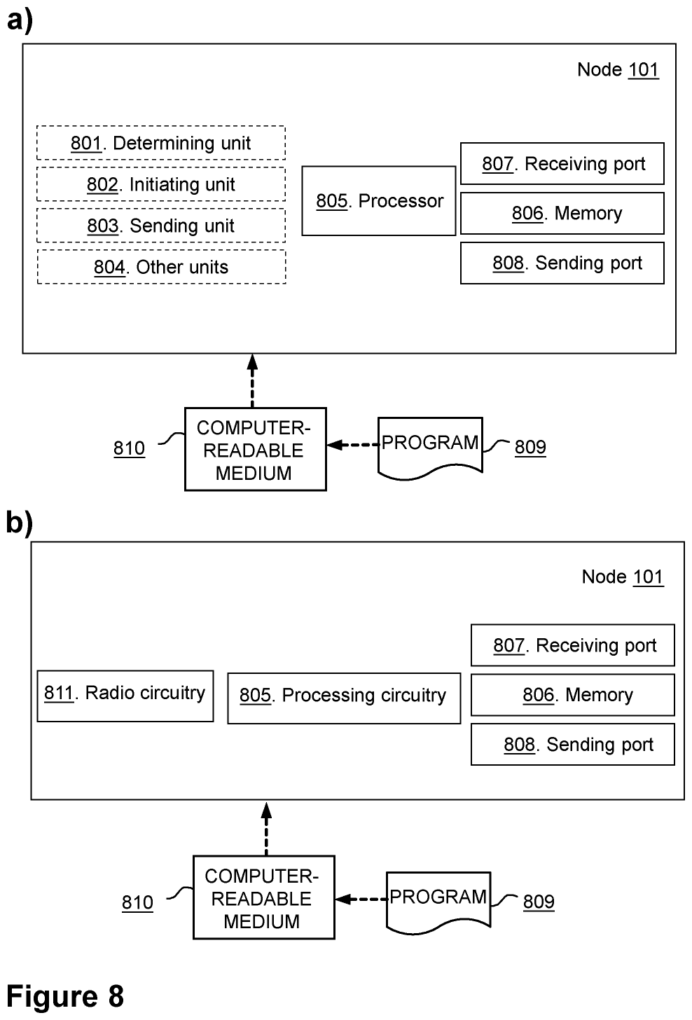

FIG. 8 depicts two different examples in panels a) and b), respectively, of the arrangement that the node 101 may comprise to perform the method actions described above in relation to FIG. 5 and/or FIG. 7. In some embodiments, the node 101 may comprise the following arrangement depicted in FIG. 8a. The node 101 may be understood to be for handling the signals. The node 101 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the node 101 and will thus not be repeated here. For example, the one or more signals to wake-up the one or more wireless devices 130 may be configured to be, e.g., Wake-Up Signals, WUSs, PEI, or equivalent.

In FIG. 8, optional units are indicated with dashed boxes.

The node 101 is configured to perform the determining of Action 502, e.g. by means of a determining unit 801 within the node 101, configured to determine the distribution of the one or more wireless devices 130 configured to be served by the node 101 into the plurality of groups. The determining is configured to be based on the division of the resources configured to be available to the node 101 into the corresponding plurality of groups. The resources are configured to comprise the at least one of: the code resources, the frequency resources and the time resources. The determined plurality of groups is configured to determine the corresponding plurality of sets of one or more signals to wake-up the one or more wireless devices 130, to be respectively monitored by the one or more wireless devices 130.

The node 101 is configured to perform the initiating of Action 504, e.g. by means of an initiating unit 802 within the node 101, configured to initiate transmitting the corresponding plurality of sets of one or more signals to wake-up the one or more wireless devices 130, based on the distribution configured to be determined, to at least one of the wireless devices 130.

In some embodiments, the node 101 may be configured to perform the sending of Action 501, e.g. by means of a sending unit 803 within the node 101, configured to send the first indication towards the one or more wireless devices 130. The first indication is configured to enable the one or more wireless devices 130 to determine the respective group to which they belong. The respective group is configured to be based on the distribution of the one or more wireless devices 130 configured to be served by the node 101 into the plurality of groups. The distribution is configured to be based on the division of the resources configured to be available to the node 101 into the corresponding plurality of groups. The resources are configured to comprise the at least one of: the code resources, the frequency resources and the time resources. The plurality of groups is configured to determine the corresponding plurality of sets of the one or more signals to wake-up the one or more wireless devices 130, to be respectively monitored by the one or more wireless devices 130.

In some embodiments, the node 101 may be configured to perform the sending of Action 503, e.g. by means of the sending unit 803, configured to send the second indication towards the at least one of the one or more wireless devices 130 configured to indicate the distribution configured to be determined to the at least one of the one or more wireless devices 130.

In some embodiments, the sending may be configured to be performed via at least one of: RRC signalling, SI, and NAS signalling.

In some embodiments, wherein the division may be configured to comprise the first division of frequency resources, the determining may be configured to be based on the following formula:

WURfrequencyResourceIndex=UE_ID mod N
wherein N may be configured to be the number of groups in the plurality of groups, WURfrequencyResourceIndex may be configured to be the configuration index of the frequency resources, and
UE_ID may be configured to be the respective identity of the respective wireless device 131.

In some embodiments, wherein the division may be configured to comprise the first division of frequency resources, every group of the plurality of groups may be configured to correspond to the respective set of frequency resources, and the respective group for the respective wireless device 131 may be configured to be determined according to the following formula:

UE_group=UE_ID mod N
wherein N may be configured to be the number of groups in the plurality of groups, and
UE_ID may be configured to be the respective identity of the respective wireless device 131.

In some embodiments, wherein the division may be configured to comprise the second division of time resources, the determining may be configured to be based on the following formula:

SFN modN=UE_ID modN
wherein N may be configured to be the number of groups in the plurality of groups,
SFN may be configured to be the System Frame Number, and
UE_ID may be configured to be the respective identity of the respective wireless device 131.

In some embodiments, wherein the division may be configured to comprise the second division of time resources, every group of the plurality of groups may be configured to correspond to the respective set of time resources, and the respective group for the respective wireless device 131 may be configured to be determined according to the following formula:

UE_group=UE_ID mod N
wherein N may be configured to be the number of groups in the plurality of groups, and
UE_ID may be configured to be the respective identity of the respective wireless device 131.

In some embodiments, every group of the plurality of groups may be configured to correspond to the respective set of time resources, and the set of resources may be configured to correspond to one of: a radio frame, a subframe, a slot and a symbol.

In some embodiments, the node 101 may be configured to be one of: the network node 110, the core network node 125, and the another wireless device 132.

Other units 804 may be comprised in the node 101.

The embodiments herein in the node 101 may be implemented through one or more processors, such as a processor 805 in the node 101 depicted in FIG. 8a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the node 101. One such carrier may be in the form of a CD ROM disc. It is however feasible with other data carriers such as a memory stick. The computer program code may furthermore be provided as pure program code on a server and downloaded to the node 101.

The node 101 may further comprise a memory 806 comprising one or more memory units. The memory 806 is arranged to be used to store obtained information, store data, configurations, schedulings, and applications etc. to perform the methods herein when being executed in the node 101.

In some embodiments, the node 101 may receive information from, e.g., the one or more wireless devices 130, the wireless device 131, the another wireless device 132, the core network node 125, and/or the network node 110, through a receiving port 807. In some embodiments, the receiving port 807 may be, for example, connected to one or more antennas in the node 101. In other embodiments, the node 101 may receive information from another structure in the wireless communications network 100 through the receiving port 807. Since the receiving port 807 may be in communication with the processor 805, the receiving port 807 may then send the received information to the processor 805. The receiving port 807 may also be configured to receive other information.

The processor 805 in the node 101 may be further configured to transmit or send information to e.g., the one or more wireless devices 130, the wireless device 131, the another wireless device 132, the core network node 125, the network node 110, and/or another structure in the wireless communications network 100, through a sending port 808, which may be in communication with the processor 805, and the memory 806.

Those skilled in the art will also appreciate that the different units 801-804 described above may refer to a combination of analog and digital modules, and/or one or more processors configured with software and/or firmware, e.g., stored in memory, that, when executed by the one or more processors such as the processor 805, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 801-804 described above may be implemented as one or more applications running on one or more processors such as the processor 805.

Thus, the methods according to the embodiments described herein for the node 101 may be respectively implemented by means of a computer program 809 product, comprising instructions, i.e., software code portions, which, when executed on at least one processor 805, cause the at least one processor 805 to carry out the actions described herein, as performed by the node 101. The computer program 809 product may be stored on a computer-readable storage medium 810. The computer-readable storage medium 810, having stored thereon the computer program 809, may comprise instructions which, when executed on at least one processor 805, cause the at least one processor 805 to carry out the actions described herein, as performed by the node 101. In some embodiments, the computer-readable storage medium 810 may be a non-transitory computer-readable storage medium, such as a CD ROM disc, or a memory stick. In other embodiments, the computer program 809 product may be stored on a carrier containing the computer program 809 just described, wherein the carrier is one of an electronic signal, optical signal, radio signal, or the computer-readable storage medium 810, as described above.

The node 101 may comprise a communication interface configured to facilitate communications between the node 101 and other nodes or devices, e.g., the one or more wireless devices 130, the wireless device 131, the another wireless device 132, the core network node 125, the network node 110 and/or another structure in the wireless communications network 100. The interface may, for example, include a transceiver configured to transmit and receive radio signals over an air interface in accordance with a suitable standard.

In other embodiments, the node 101 may comprise the following arrangement depicted in FIG. 8b. The node 101 may comprise a processing circuitry 805, e.g., one or more processors such as the processor 805, in the node 101 and the memory 806. The node 101 may also comprise a radio circuitry 811, which may comprise e.g., the receiving port 807 and the sending port 808. The processing circuitry 805 may be configured to, or operable to, perform the method actions according to FIG. 5 and/or FIG. 7, in a similar manner as that described in relation to FIG. 8a. The radio circuitry 811 may be configured to set up and maintain at least a wireless connection with the one or more wireless devices 130, the wireless device 131, the another wireless device 132, the core network node 125, the network node 110 and/or another structure in the wireless communications network 100. Circuitry may be understood herein as a hardware component.

Hence, embodiments herein also relate to the node 101 comprising the processing circuitry 805 and the memory 806, said memory 806 containing instructions executable by said processing circuitry 805, whereby the node 101 is operative to perform the actions described herein in relation to the node 101, e.g., in FIG. 5 and/or FIG. 7.

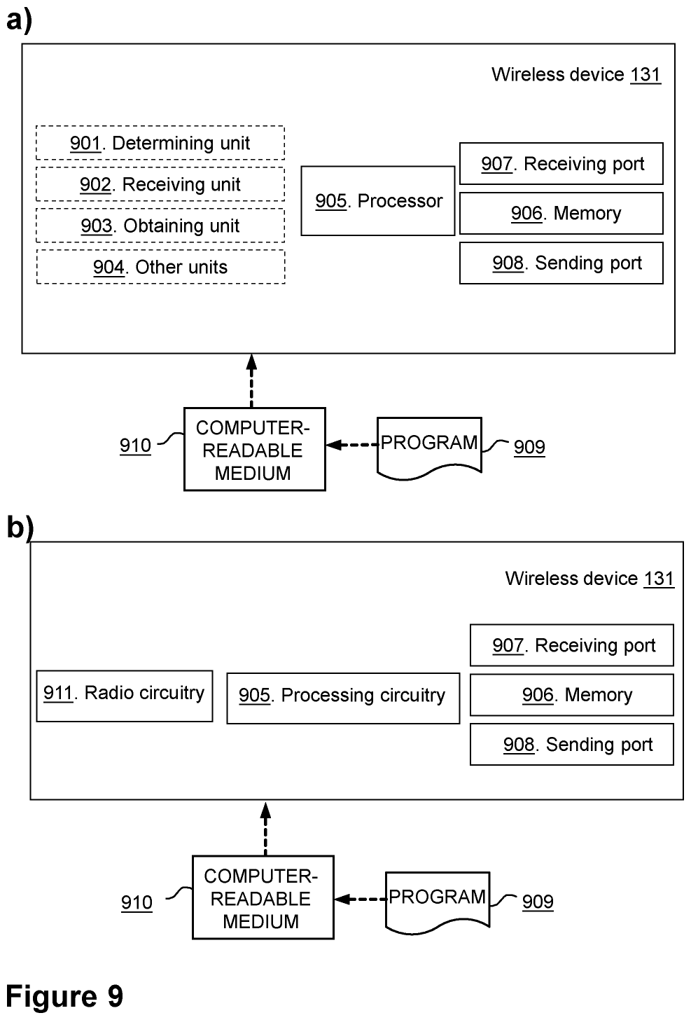

FIG. 9 depicts two different examples in panels a) and b), respectively, of the arrangement that the wireless device 131 may comprise to perform the method actions described above in relation to FIG. 6 and/or FIG. 7. In some embodiments, the wireless device 131 may comprise the following arrangement depicted in FIG. 9a. The wireless device 131 may be understood to be for handling the signals. The wireless device 131 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 131 and will thus not be repeated here. For example, the downlink signal to wake-up the wireless device 131 may be, e.g., a WUS.

In FIG. 9, optional units are indicated with dashed boxes.

The wireless device 131 is configured to perform the determining of Action 603, e.g. by means of a determining unit 901 within the wireless device 131, configured to determine the respective group to which the wireless device 131 belongs. The respective group is configured to be based on the distribution of the one or more wireless devices 130 configured to be served by the node 101 configured to operate in the wireless communications network 100 into the plurality of groups. The distribution is configured to be based on the division of resources available to the node 101 into the corresponding plurality of groups. The resources are configured to comprise the at least one of: the code resources, the frequency resources and the time resources. The determined plurality of groups is configured to determine the corresponding plurality of sets of one or more signals to wake-up the one or more wireless devices 130, to be respectively monitored by the one or more wireless devices 130.

The wireless device 131 is configured to perform the receiving of Action 604, e.g. by means of a receiving unit 902, configured to receive the corresponding set of one or more signals to wake-up the wireless device 131, based on the respective group configured to be determined.

In some embodiments, the wireless device 131 may be configured to perform the obtaining of Action 601, e.g. by means of an obtaining unit 903 comprised in the wireless device 131, configured to obtain the first indication from the node 101. The first indication may be configured to enable the wireless device 131 to determine the respective group to which the wireless device 131 may belong. The respective group may be configured to be based on the distribution of the one or more wireless devices 130 configured to be served by the node 101 configured to operate in the wireless communications network 100 into the plurality of groups. The distribution may be configured to be based on the division of resources configured to be available to the node 101 into the corresponding plurality of groups. The resources may be configured to comprise the at least one of: the code resources, the frequency resources and the time resources. The determined plurality of groups may be configured to determine the corresponding plurality of sets of one or more signals to wake-up the one or more wireless devices 130, to be respectively monitored by the one or more wireless devices 130. The determining may be configured to be based on the first indication configured to be obtained.

In some embodiments, the wireless device 131 may be configured to perform the obtaining of Action 602, e.g. by means of the obtaining unit 903 within the wireless device 131, configured to obtain the second indication configured to indicate the distribution from the node 101. The determining may be configured to be based on the second indication configured to be obtained.

In some embodiments, the obtaining may be configured to be performed via at least one of: RRC signalling, SI, and NAS signalling.

In some embodiments, wherein the division may be configured to comprise the first division of frequency resources, the determining may be configured to be based on the following formula:

WURfrequencyResourceIndex=UE_ID mod N
wherein N may be configured to be the number of groups in the plurality of groups, WURfrequencyResourceIndex may be configured to be the configuration index of the frequency resources, and
UE_ID may be configured to be the respective identity of the respective wireless device 131.

In some embodiments, wherein the division may be configured to comprise the first division of frequency resources, every group of the plurality of groups may be configured to correspond to the respective set of frequency resources, and the respective group for the respective wireless device 131 may be configured to be determined according to the following formula:

UE_group=UE_ID mod N
wherein N may be configured to be the number of groups in the plurality of groups, and
UE_ID may be configured to be the respective identity of the respective wireless device 131.

In some embodiments, wherein the division may be configured to comprise the second division of time resources, the determining may be configured to be based on the following formula:

SFN modN=UE_ID modN
wherein N may be configured to be the number of groups in the plurality of groups,
SFN may be configured to be the System Frame Number, and
UE_ID may be configured to be the respective identity of the respective wireless device 131.

In some embodiments, wherein the division may be configured to comprise the second division of time resources, every group of the plurality of groups may be configured to correspond to the respective set of time resources, and the respective group for the respective wireless device 131 may be configured to be determined according to the following formula:

UE_group=UE_ID mod N
wherein N may be configured to be the number of groups in the plurality of groups, and
UE_ID may be configured to be the respective identity of the respective wireless device 131.

In some embodiments, every group of the plurality of groups may be configured to correspond to the respective set of time resources, and the set of resources may be configured to correspond to one of: a radio frame, a subframe, a slot and a symbol.

In some embodiments, the node 101 may be configured to be one of: the network node 110, the core network node 125, and the another wireless device 132.

Other units 904 may be comprised in the wireless device 131.

The embodiments herein in the wireless device 131 may be implemented through one or more processors, such as a processor 905 in the wireless device 131 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131. One such carrier may be in the form of a CD ROM disc. It is however feasible with other data carriers such as a memory stick. The computer program code may furthermore be provided as pure program code on a server and downloaded to the wireless device 131.

The wireless device 131 may further comprise a memory 906 comprising one or more memory units. The memory 906 is arranged to be used to store obtained information, store data, configurations, schedulings, and applications etc. to perform the methods herein when being executed in the wireless device 131.

In some embodiments, the wireless device 131 may receive information from, e.g., the node 101, the another wireless device 132, any of the other wireless devices of the one or more wireless devices 130, the core network node 125, and/or the network node 110, through a receiving port 907. In some embodiments, the receiving port 907 may be, for example, connected to one or more antennas in wireless device 131. In other embodiments, the wireless device 131 may receive information from another structure in the wireless communications network 100 through the receiving port 907. Since the receiving port 907 may be in communication with the processor 905, the receiving port 907 may then send the received information to the processor 905. The receiving port 907 may also be configured to receive other information.

The processor 905 in the wireless device 131 may be further configured to transmit or send information to e.g., the node 101, the another wireless device 132, any of the other wireless devices of the one or more wireless devices 130, the core network node 125, the network node 110, and/or or another structure in the wireless communications network 100, through a sending port 908, which may be in communication with the processor 905, and the memory 906.

Those skilled in the art will also appreciate that the different units 901-904 described above may refer to a combination of analog and digital modules, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-904 described above may be implemented as one or more applications running on one or more processors such as the processor 905.

Thus, the methods according to the embodiments described herein for the wireless device 131 may be respectively implemented by means of a computer program 909 product, comprising instructions, i.e., software code portions, which, when executed on at least one processor 905, cause the at least one processor 905 to carry out the actions described herein, as performed by the wireless device 131. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the wireless device 131. In some embodiments, the computer-readable storage medium 910 may be a non-transitory computer-readable storage medium, such as a CD ROM disc, or a memory stick. In other embodiments, the computer program 909 product may be stored on a carrier containing the computer program 909 just described, wherein the carrier is one of an electronic signal, optical signal, radio signal, or the computer-readable storage medium 910, as described above.

The wireless device 131 may comprise a communication interface configured to facilitate communications between the wireless device 131 and other nodes or devices, e.g., the node 101, the another wireless device 132, any of the other wireless devices of the one or more wireless devices 130, the core network node 125, the network node 110 and/or another structure in the wireless communications network 100. The interface may, for example, include a transceiver configured to transmit and receive radio signals over an air interface in accordance with a suitable standard.

In other embodiments, the wireless device 131 may comprise the following arrangement depicted in FIG. 9b. The wireless device 131 may comprise a processing circuitry 905, e.g., one or more processors such as the processor 905, in the wireless device 131 and the memory 906. The wireless device 131 may also comprise a radio circuitry 911, which may comprise e.g., the receiving port 907 and the sending port 908. The processing circuitry 911 may be configured to, or operable to, perform the method actions according to FIG. 6 and/or FIG. 7, in a similar manner as that described in relation to FIG. 9a. The radio circuitry 911 may be configured to set up and maintain at least a wireless connection with the node 101, the another wireless device 132, any of the other wireless devices of the one or more wireless devices 130, the core network node 125, the network node 110 and/or another structure in the wireless communications network 100. Circuitry may be understood herein as a hardware component.

Hence, embodiments herein also relate to the wireless device 131 comprising the processing circuitry 905 and the memory 906, said memory 906 containing instructions executable by said processing circuitry 905, whereby the wireless device 131 is operative to perform the actions described herein in relation to the wireless device 131, e.g., in FIG. 6 and/or FIG. 7.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples of, or Related to, Embodiments Herein

Examples related to embodiments herein may be as follows.

The node 101 embodiments relate to FIG. 5, FIG. 7, FIG. 8 and FIGS. 10-15.

A method, performed by a node, such as the node 101 is described herein. The method may be understood to be for handling signals. The node 101 may be operating in a wireless communications network, such as the wireless communications network 100.

The node 101 may be one of: the network node 110, the core network node 125, and the another wireless device 132.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The method may comprise one or more of the following actions. In some embodiments, all the actions may be performed. In some embodiments, two actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 5. In FIG. 5, optional actions in some embodiments may be represented with dashed lines.
Determining 502 a distribution. The node 101 may be configured to perform this determining action 502, e.g. by means of a determining unit 801 within the node 101, configured to perform this action.

The distribution may be of the one or more wireless devices 130. The distribution may be into a plurality of groups. The one or more wireless devices 130 may be served by the node 101.

The determining 502 in this Action may be based on a division of resources into a corresponding plurality of groups. The resources may be available to the node 101.

The resources may comprise at least one of: code resources, frequency resources and time resources.

The determined plurality of groups may determine a corresponding plurality of sets of one or more signals. The one or more signals may be to wake-up the one or more wireless devices 130. The one or more signals may be, e.g., Wake-Up Signals, WUSs, PEI, or equivalent.

The one or more signals may be to be respectively monitored by the one or more wireless devices 130.

Determining in this Action 502 may comprise deciding, deriving or calculating autonomously, receiving from another node, or retrieving from a memory.

In some examples, the division may comprise a first division of frequency resources. In some of such examples, the determining in this Action 502 may be based on the following formula: WURfrequencyResourceIndex=UE_ID mod N
wherein N may be a number of groups in the plurality of groups, WURfrequencyResourceIndex may be a configuration index of the frequency resources, and
UE_ID may be a respective identity of a respective wireless device, e.g., the wireless device 131.

In other examples wherein the division may comprise the first division of frequency resources, every group of the plurality of groups may correspond to a respective set of frequency resources. A respective group for a respective wireless device, e.g., the wireless device 131, may be determined according to the following formula: UE_group=UE_ID mod N
wherein N may be a number of groups in the plurality of groups, and
UE_ID may be a respective identity of a respective wireless device 131.

In some examples, the division may comprise a second division of time resources. In some of such examples, the determining in this Action 502 may be based on the following formula: SFN modN=UE_ID modN
wherein N may be a number of groups in the plurality of groups,
SFN may be a System Frame Number, and
UE_ID may be a respective identity of a respective wireless device, e.g., the wireless device 131.

In other examples wherein the division may comprise the second division of time resources, every group of the plurality of groups may correspond to a respective set of time resources. A respective group for the respective wireless device, e.g., the wireless device 131 may be determined according to the following formula: UE_group=UE_ID mod N
wherein N may be a number of groups in the plurality of groups, and
UE_ID may be a respective identity of a respective wireless device 131.

In some examples, every group of the plurality of groups may correspond to a respective set of time resources. The set of resources may correspond to one of: a subframe, a slot and a symbol.

The determining in this Action 502 may be based on a respective capability of the one or more wireless devices 130, which may have been obtained by the node 101.
Initiating 504 transmitting the corresponding plurality of sets of one or more signals to wake-up the one or more wireless devices 130, e.g., WUSs or PEI. The node 101 may be configured to perform this initiating Action 504, e.g. by means of an initiating unit 802 within the node 101, configured to perform this action.

Transmitting may be, e.g., sending.

Initiating may be understood as triggering, enabling, facilitating or starting. For example, in examples wherein the node 101 may be the core network node 125, the node 101 may enable the network node 110 to perform the transmission, e.g., via the first link 141. In examples wherein the node 101 may be the network node 110 or the another wireless device 132, the node 101 may start performing the transmission, e.g., via the first link 141 or the third link 143, respectively.

The initiating transmitting in this Action 504 of the corresponding plurality of sets of one or more signals to wake-up the one or more wireless devices 130, e.g., WUSs or PEI, may be based on the determined distribution to at least one of the wireless devices 130.

In some embodiments, the method may further comprise one or more of the following actions:
Sending 501 a first indication. The node 101 may be configured to perform this sending action 501, e.g. by means of a sending unit 803 within the node 101, configured to perform this action.

The sending in this Action 501 may be towards the one or more wireless devices 130. Towards may be understood to mean directly, e.g., from the network node 110, or indirectly, e.g., from the core network node 125.

The first indication may enable the one or more wireless devices 130 to determine a respective group to which they may belong.

The respective group may be based on the distribution of the one or more wireless devices 130 served by the node 101 into the plurality of groups.

The distribution may be based on the division of resources available to the node 101 into the corresponding plurality of groups.

The resources may comprise at least one of: code resources, frequency resources and time resources.

The determined plurality of groups may determine the corresponding plurality of sets of the one or more signals to wake-up the one or more wireless devices 130, e.g., WUSs or PEI, to be respectively monitored by the one or more wireless devices 130.

The sending in this Action 501 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.
Sending 503 a second indication. The node 101 may be configured to perform this sending action 503, e.g. by means of the sending unit 803, configured to perform this action.

The sending in this Action 503 may be towards the one or more wireless devices 130. Towards may be understood to mean directly, e.g., from the network node 110, or indirectly, e.g., from the core network node 125.

The second indication may indicate the determined distribution to the at least one of the one or more wireless devices 130.

The sending in any of Action 501 and/or Action 503 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.

Other units 804 may be comprised in the node 101.

The node 101 may also be configured to communicate user data with a host application unit in a host computer 1110, e.g., via another link such as 1160.

In FIG. 8, optional units are indicated with dashed boxes.

The node 101 may comprise an interface unit to facilitate communications between the node 101 and other nodes or devices, e.g., the one or more wireless device 130, the wireless device 131, the network node 110, the host computer 1110, or any of the other nodes. In some particular examples, the interface may, for example, include a transceiver configured to transmit and receive radio signals over an air interface in accordance with a suitable standard.

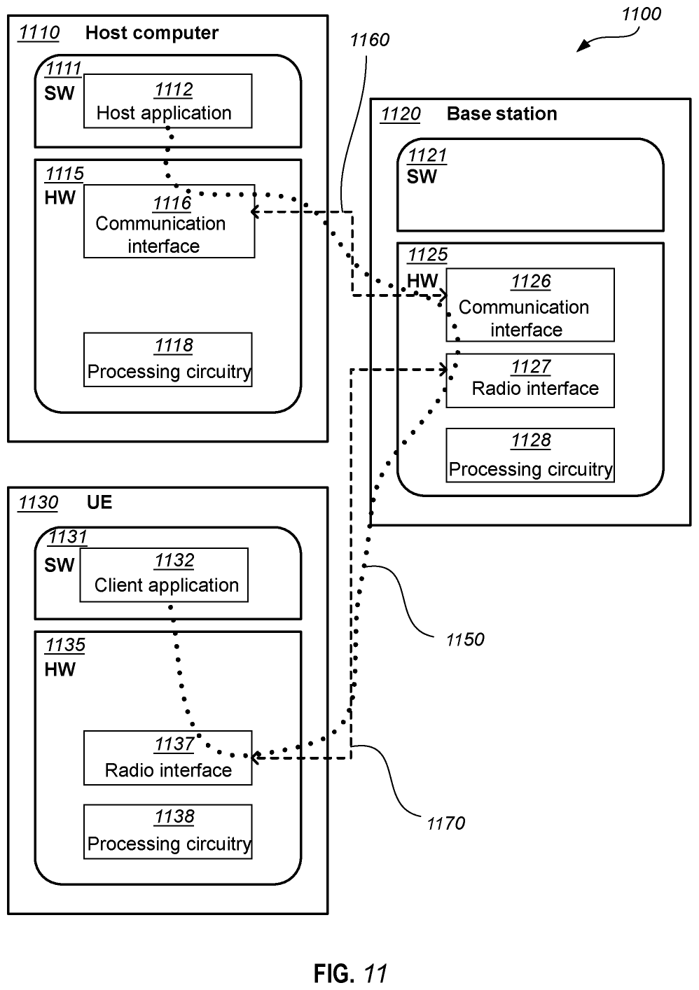

The node 101 may comprise an arrangement as shown in FIG. 8 or in FIG. 11.

The wireless device 131 embodiments relate to FIG. 6, FIG. 7, FIG. 9 and FIGS. 10-15.

A method, performed by a wireless device, such as the wireless device 131 is described herein. The method may be understood to be for handling signals. The wireless device 131 may be operating in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 6. In FIG. 6, optional actions in some embodiments may be represented with dashed lines.

The detailed description of some of the following corresponds to the same references provided above, in relation to the actions described for the node 101 and will thus not be repeated here to simplify the description. For example, the one or more signals to wake-up the one or more wireless devices 130 may be, e.g., Wake-Up Signals, WUSs, PEI, or equivalent.
Determining 603 a respective group. The wireless device 131 may be configured to perform this determining action 603, e.g. by means of a determining unit 901 within the wireless device 131, configured to perform this action.

The respective group may be to which the wireless device 131 may belong.

The respective group may be based on the distribution of one or more wireless devices 130. The one or more wireless devices 130 may be served by the node 101 operating in the wireless communications network 100.

The distribution may be into the plurality of groups.

The distribution may be based on the division of resources.

The resources may be available to the node 101.

The node 101 may be one of: the network node 110, the core network node 125, and the another wireless device 132.

The division of resources may be into the corresponding plurality of groups.

The resources may comprise at least one of: code resources, frequency resources and time resources.

The determined plurality of groups may determine the corresponding plurality of sets of one or more signals. The one or more signals may be to wake-up the one or more wireless devices 130.

The one or more signals may be to be respectively monitored by the one or more wireless devices 130.

Determining in this Action 603 may comprise deciding, deriving or calculating autonomously, receiving from another node, or retrieving from a memory.

In some examples, the division may comprise the first division of frequency resources. In some of such examples, the determining in this Action 603 may be based on the following formula: WURfrequencyResourceIndex=UE_ID mod N
wherein N may be the number of groups in the plurality of groups, WURfrequencyResourceIndex may be the configuration index of the frequency resources, and
UE_ID may be the respective identity of a respective wireless device, e.g., the wireless device 131. Accordingly, the wireless device 131 may use its respective UE-ID to perform the determining of Action 603.

In other examples wherein the division may comprise the first division of frequency resources, every group of the plurality of groups may correspond to a respective set of frequency resources. The respective group for the respective wireless device, e.g., the wireless device 131, may be determined according to the following formula: UE_group=UE_ID mod N
wherein N may be the number of groups in the plurality of groups, and
UE_ID may be the respective identity of the respective wireless device, e.g., the wireless device 131. Accordingly, the wireless device 131 may use its respective UE-ID to perform the determining of Action 603.

In some examples, the division may comprise the second division of time resources. In some of such examples, the determining in this Action 603 may be based on the following formula: SFN modN=UE_ID modN
wherein N may be the number of groups in the plurality of groups,
SFN may be the System Frame Number, and
UE_ID may be the respective identity of the respective wireless device, e.g., the wireless device 131. Accordingly, the wireless device 131 may use its respective UE-ID to perform the determining of Action 603.

In other examples wherein the division may comprise the second division of time resources, every group of the plurality of groups may correspond to the respective set of time resources. A respective group for the respective wireless device, e.g., the wireless device 131 may be determined according to the following formula: UE_group=UE_ID mod N
wherein N may be the number of groups in the plurality of groups, and
UE_ID may be the respective identity of the respective wireless device 131. Accordingly, the wireless device 131 may use its respective UE-ID to perform the determining of Action 603.

In some examples, every group of the plurality of groups may correspond to a respective set of time resources. The set of resources may correspond to one of: a subframe, a slot and a symbol.

The determining in this Action 602 may be based on a respective capability of the wireless device 131, which may have been provided to the node 101.
Receiving 604 the corresponding set of one or more signals. The wireless device 131 may be configured to perform this receiving action 604, e.g. by means of a receiving unit 902, configured to perform this action.

The one or more signals may be to wake-up the wireless device 131, based on the determined respective group.

The receiving in this Action 604 may be performed, e.g., via the first link 141, or the third link 143.

In some embodiments, the method may further comprise one or more of the following actions:
Obtaining 601 the first indication. The wireless device 131 may be configured to perform this obtaining action 601, e.g. by means of an obtaining unit 903 comprised in the wireless device 131, configured to perform this action.

Obtaining may be receiving from another node, or retrieving from a memory.

The obtaining, e.g., receiving, in this Action 601 may be from the node 101. This may be directly, e.g., from the network node 110 or the another wireless device 132, or indirectly, e.g., from the core network node 125.

The first indication may enable the wireless device 131 to determine the respective group to which the wireless device 131 may belong.

The respective group may be based on the distribution of the one or more wireless devices 130. The one or more wireless devices 130 may be served by the node 101 into the plurality of groups.

The distribution may be based on the division of resources available to the node 101 into the corresponding plurality of groups.

The resources may comprise at least one of: code resources, frequency resources and time resources.

The determined plurality of groups may determine the corresponding plurality of sets of the one or more signals to wake-up the one or more wireless devices 130, e.g., WUSs or PEI, to be respectively monitored by the one or more wireless devices 130.

The determining in Action 603 may be based on the obtained first indication.

In some embodiments, the method may further comprise one or more of the following actions:
Obtaining 602 the second indication. The wireless device 131 may be configured to perform this obtaining action 602, e.g. by means of the obtaining unit 903 within the wireless device 131, configured to perform this action.

Obtaining may be receiving from another node, or retrieving from a memory.

The obtaining in this Action 602 may be from the node 101, directly, e.g., from the network node 110, or indirectly, e.g., from the core network node 125.

The second indication may indicate the distribution.

The determining in Action 603 may be based on the obtained second indication.

The receiving in any of Action 601 and/or Action 602 may be performed via at least one of: Radio Resource Control (RRC) signalling, via System Information (SI) and via NAS signalling. The obtaining via RRC or SI may be performed in examples wherein the node 101 may be the network node 110. The obtaining via NAS signalling may be performed in examples wherein the node 101 may be the core network node 125. In other examples, wherein the node 101 may be the another wireless device 132, the obtaining in any of Action 601 and/or Action 602 may be performed via a SL, e.g., D2D communication.

Other units 904 may be comprised in the wireless device 131.

The wireless device 131 may also be configured to communicate user data with a host application unit in a host computer 1110, e.g., via another link such as 1160.

In FIG. 9, optional units are indicated with dashed boxes.

The wireless device 131 may comprise an interface unit to facilitate communications between the wireless device 131 and other nodes or devices, e.g., the node 101, the network node 110, the core network node 125, the another wireless device 132, any of the other one or more wireless devices 130, the host computer 1110, or any of the other nodes. In some particular examples, the interface may, for example, include a transceiver configured to transmit and receive radio signals over an air interface in accordance with a suitable standard.

The wireless device 131 may comprise an arrangement as shown in FIG. 9 or in FIG. 11.

Numbered examples related to embodiments herein:

Example 1. A method performed by a node (101), the method being for handling signals, the node (101) operating in a wireless communications network (100), and the method comprising:
determining (502) a distribution of one or more wireless devices (130) served by the node (101) into a plurality of groups, wherein the determining (502) is based on a division of resources available to the node (101) into a corresponding plurality of groups, the resources comprising at least one of: code resources, frequency resources and time resources, wherein the determined plurality of groups determines a corresponding plurality of sets of one or more signals to wake-up the one or more wireless devices (130), e.g., Wake-Up Signals, WUSs, to be respectively monitored by the one or more wireless devices (130), and
initiating (504) transmitting the corresponding plurality of sets of one or more signals to wake-up the one or more wireless devices (130), e.g., WUSs, based on the determined distribution to at least one of the wireless devices (130).
   Example 2. The method according to example 1, further comprising:
sending (501) a first indication towards the one or more wireless devices (130), the first indication enabling the one or more wireless devices (130) to determine a respective group to which they belong, the respective group being based on the distribution of the one or more wireless devices (130) served by the node (101) into the plurality of groups, wherein the distribution is based on the division of resources available to the node (101) into the corresponding plurality of groups, the resources comprising at least one of: code resources, frequency resources and time resources, wherein the determined plurality of groups determines the corresponding plurality of sets of the one or more signals to wake-up the one or more wireless devices (130), e.g., WUSs, to be respectively monitored by the one or more wireless devices (130).
   Example 3. The method according to any of example 1-2, further comprising:
sending (503) a second indication towards the at least one of the one or more wireless devices (130) indicating the determined distribution to the at least one of the one or more wireless devices (130).
   Example 4. The method according to examples 2-3, wherein the sending (501, 503) is performed via at least one of: Radio Resource Control, RRC, signalling, System Information, SI, and non-access stratum, NAS, signalling.
   Example 5. The method according to any of examples 1-4, wherein the division comprises a first division of frequency resources, and wherein the determining (502) is based on the following formula:

WURfrequencyResourceIndex=UE_ID mod N
wherein N is a number of groups in the plurality of groups, WURfrequencyResourceIndex is a configuration index of the frequency resources, and
UE_ID is a respective identity of a respective wireless device (131).
   Example 6. The method according to any of examples 1-4, wherein the division comprises a first division of frequency resources, wherein every group of the plurality of groups corresponds to a respective set of frequency resources, and wherein a respective group for a respective wireless device (131) is determined according to the following formula:

UE_group=UE_ID mod N
wherein N is a number of groups in the plurality of groups, and
UE_ID is a respective identity of a respective wireless device (131).
   Example 7. The method according to any of examples 1-6, wherein the division comprises a second division of time resources, and wherein the determining (502) is based on the following formula:

SFN mod(N)=UE_ID mod(N)
wherein N is a number of groups in the plurality of groups,
SFN is a System Frame Number, and
UE_ID is a respective identity of a respective wireless device (131).
   Example 8. The method according to any of examples 1-6, wherein the division comprises a second division of time resources, wherein every group of the plurality of groups corresponds to a respective set of time resources, and wherein a respective group for a respective wireless device (131) is determined according to the following formula:

UE_group=UE_ID mod N
wherein N is a number of groups in the plurality of groups, and
UE_ID is a respective identity of a respective wireless device (131).
   Example 9. The method according to any of examples 1-6 or example 8, wherein every group of the plurality of groups corresponds to a respective set of time resources, and wherein the set of resources correspond to one of: a subframe, a slot and a symbol.
   Example 10. The method according to any of examples 1-9, wherein the node (101) is one of: a network node (110), a core network node (125), and another wireless device (132).
   Example 11. A method performed by a wireless device (131), the method being for handling signals, the wireless device (131) operating in a wireless communications network (100), and the method comprising:
determining (603) a respective group to which the wireless device (131) belongs, the respective group being based on a distribution of one or more wireless devices (130) served by a node (101) operating in the wireless communications network (100) into a plurality of groups, wherein the distribution is based on a division of resources available to the node (101) into a corresponding plurality of groups, the resources comprising at least one of: code resources, frequency resources and time resources, wherein the determined plurality of groups determines a corresponding plurality of sets of one or more signals to wake-up the one or more wireless devices (130), e.g., Wake-Up Signals, WUSs, to be respectively monitored by the one or more wireless devices (130), and
receiving (604) the corresponding set of one or more signals to wake-up the wireless device (131), e.g., WUSs, based on the determined respective group.
   Example 12. The method according to example 11, further comprising:
obtaining (601) a first indication from the node (101), the first indication enabling the wireless device (131) to determine the respective group to which the wireless device (131) belongs, the respective group being based on the distribution of the one or more wireless devices (130) served by the node (101) operating in the wireless communications network (100) into the plurality of groups, wherein the distribution is based on the division of resources available to the node (101) into the corresponding plurality of groups, the resources comprising at least one of: code resources, frequency resources and time resources, wherein the determined plurality of groups determines the corresponding plurality of sets of one or more signals to wake-up the one or more wireless devices (130), e.g., Wake-Up Signals, WUSs, to be respectively monitored by the one or more wireless devices (130), and wherein the determining (603) is based on the obtained first indication.
   Example 13. The method according to any of example 11-12, further comprising:
obtaining (602) a second indication indicating the distribution from the node (101), and wherein the determining (603) is based on the obtained second indication.
   Example 14. The method according to examples 12-13, wherein the obtaining (601, 602) is performed via at least one of: Radio Resource Control, RRC, signalling, System Information, SI, and non-access stratum, NAS, signalling.
   Example 15. The method according to any of examples 11-14, wherein the division comprises a first division of frequency resources, and wherein the determining (603) is based on the following formula:

WURfrequencyResourceIndex=UE_ID mod N
wherein N is a number of groups in the plurality of groups, WURfrequencyResourceIndex is a configuration index of the frequency resources, and
UE_ID is a respective identity of a respective wireless device (131).
   Example 16. The method according to any of examples 11-15, wherein the division comprises a first division of frequency resources, wherein every group of the plurality of groups corresponds to a respective set of frequency resources, and wherein a respective group for a respective wireless device (131) is determined according to the following formula:

UE_group=UE_ID mod N
wherein N is a number of groups in the plurality of groups, and
UE_ID is a respective identity of a respective wireless device (131).
   Example 17. The method according to any of examples 11-16, wherein the division comprises a second division of time resources, and wherein the determining (602) is based on the following formula:

SFN mod(N)=UE_ID mod(N)
wherein N is a number of groups in the plurality of groups,
SFN is a System Frame Number, and
UE_ID is a respective identity of a respective wireless device (131).
   Example 18. The method according to any of examples 11-16, wherein the division comprises a second division of time resources, wherein every group of the plurality of groups corresponds to a respective set of time resources, and wherein a respective group for a respective wireless device (131) is determined according to the following formula:

UE_group=UE_ID mod N
wherein N is a number of groups in the plurality of groups, and
UE_ID is a respective identity of a respective wireless device (131).
   Example 19. The method according to any of examples 11-16 or example 18 wherein every group of the plurality of groups corresponds to a respective set of time resources, and wherein the set of resources correspond to one of: a subframe, a slot and a symbol.
   Example 20. The method according to any of examples 11-19, wherein the node (101) is one of: a network node (110), a core network node (125), and another wireless device (132).

### Further Extensions And Variations

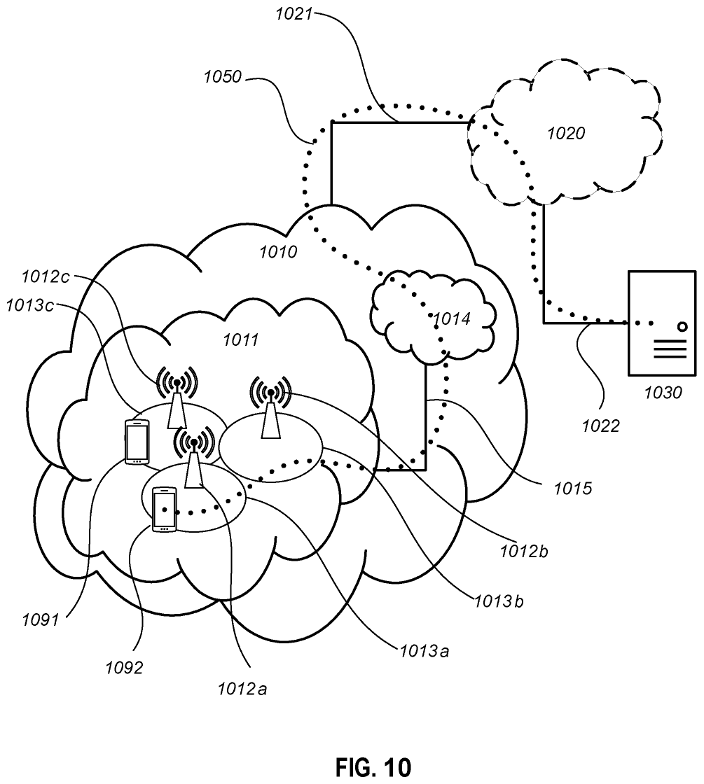

FIG. 10: Telecommunication network connected via an intermediate network to a host computer in accordance with some embodiments

With reference to FIG. 10, in accordance with an embodiment, a communication system includes telecommunication network 1010 such as the wireless communications network 100, for example, a 3GPP-type cellular network, which comprises access network 1011, such as a radio access network, and core network 1014. Access network 1011 comprises a plurality of network nodes such as the network node 110. For example, base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to core network 1014 over a wired or wireless connection 1015. A plurality of wireless devices, such as any of the another wireless device 132, or any of the one or more wireless devices, e.g., the wireless device 131 are comprised in the wireless communications network 100. In FIG. 10, a first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012. Any of the UEs 1091, 1092 are examples of any of the another wireless device 132, or any of the one or more wireless devices, e.g., the wireless device 131.

Telecommunication network 1010 is itself connected to host computer 1030, which may be embodied in the hardware and/or software of a standalone server, a cloud-implemented server, a distributed server or as processing resources in a server farm. Host computer 1030 may be under the ownership or control of a service provider, or may be operated by the service provider or on behalf of the service provider. Connections 1021 and 1022 between telecommunication network 1010 and host computer 1030 may extend directly from core network 1014 to host computer 1030 or may go via an optional intermediate network 1020. Intermediate network 1020 may be one of, or a combination of more than one of, a public, private or hosted network; intermediate network 1020, if any, may be a backbone network or the Internet; in particular, intermediate network 1020 may comprise two or more sub-networks (not shown).

The communication system of FIG. 10 as a whole enables connectivity between the connected UEs 1091, 1092 and host computer 1030. The connectivity may be described as an over-the-top (OTT) connection 1050. Host computer 1030 and the connected UEs 1091, 1092 are configured to communicate data and/or signaling via OTT connection 1050, using access network 1011, core network 1014, any intermediate network 1020 and possible further infrastructure (not shown) as intermediaries. OTT connection 1050 may be transparent in the sense that the participating communication devices through which OTT connection 1050 passes are unaware of routing of uplink and downlink communications. For example, base station 1012 may not or need not be informed about the past routing of an incoming downlink communication with data originating from host computer 1030 to be forwarded (e.g., handed over) to a connected UE 1091. Similarly, base station 1012 need not be aware of the future routing of an outgoing uplink communication originating from the UE 1091 towards the host computer 1030.

In relation to FIGS. 11, 12, 13, 14, and 15, which are described next, it may be understood that a UE is an example of any of the another wireless device 132, or any of the one or more wireless devices, e.g., the wireless device 131, and that any description provided for the UE equally applies to any of the another wireless device 132, or any of the one or more wireless devices, e.g., the wireless device 131. It may be also understood that the base station is an example of the network node 110, and that any description provided for the base station equally applies to the network node 110.

FIG. 11: Host computer communicating via a base station with a user equipment over a partially wireless connection in accordance with some embodiments

Example implementations, in accordance with an embodiment, of any of the another wireless device 132, or any of the one or more wireless devices, e.g., the wireless device 131, e.g., a UE, the network node 110, e.g., a base station and host computer discussed in the preceding paragraphs will now be described with reference to FIG. 11. In communication system 1100, such as the wireless communications network 100, host computer 1110 comprises hardware 1115 including communication interface 1116 configured to set up and maintain a wired or wireless connection with an interface of a different communication device of communication system 1100. Host computer 1110 further comprises processing circuitry 1118, which may have storage and/or processing capabilities. In particular, processing circuitry 1118 may comprise one or more programmable processors, application-specific integrated circuits, field programmable gate arrays or combinations of these (not shown) adapted to execute instructions. Host computer 1110 further comprises software 1111, which is stored in or accessible by host computer 1110 and executable by processing circuitry 1118. Software 1111 includes host application 1112. Host application 1112 may be operable to provide a service to a remote user, such as UE 1130 connecting via OTT connection 1150 terminating at UE 1130 and host computer 1110. In providing the service to the remote user, host application 1112 may provide user data which is transmitted using OTT connection 1150.

Communication system 1100 further includes the network node 110, exemplified in FIG. 11 as a base station 1120 provided in a telecommunication system and comprising hardware 1125 enabling it to communicate with host computer 1110 and with UE 1130. Hardware 1125 may include communication interface 1126 for setting up and maintaining a wired or wireless connection with an interface of a different communication device of communication system 1100, as well as radio interface 1127 for setting up and maintaining at least wireless connection 1170 with any of the another wireless device 132, or any of the one or more wireless devices, e.g., the wireless device 131, exemplified in FIG. 11 as a UE 1130 located in a coverage area (not shown in FIG. 11) served by base station 1120. Communication interface 1126 may be configured to facilitate connection 1160 to host computer 1110. Connection 1160 may be direct or it may pass through a core network (not shown in FIG. 11) of the telecommunication system and/or through one or more intermediate networks outside the telecommunication system. In the embodiment shown, hardware 1125 of base station 1120 further includes processing circuitry 1128, which may comprise one or more programmable processors, application-specific integrated circuits, field programmable gate arrays or combinations of these (not shown) adapted to execute instructions. Base station 1120 further has software 1121 stored internally or accessible via an external connection.

Communication system 1100 further includes UE 1130 already referred to. Its hardware 1135 may include radio interface 1137 configured to set up and maintain wireless connection 1170 with a base station serving a coverage area in which UE 1130 is currently located. Hardware 1135 of UE 1130 further includes processing circuitry 1138, which may comprise one or more programmable processors, application-specific integrated circuits, field programmable gate arrays or combinations of these (not shown) adapted to execute instructions. UE 1130 further comprises software 1131, which is stored in or accessible by UE 1130 and executable by processing circuitry 1138. Software 1131 includes client application 1132. Client application 1132 may be operable to provide a service to a human or non-human user via UE 1130, with the support of host computer 1110. In host computer 1110, an executing host application 1112 may communicate with the executing client application 1132 via OTT connection 1150 terminating at UE 1130 and host computer 1110. In providing the service to the user, client application 1132 may receive request data from host application 1112 and provide user data in response to the request data. OTT connection 1150 may transfer both the request data and the user data. Client application 1132 may interact with the user to generate the user data that it provides.

It is noted that host computer 1110, base station 1120 and UE 1130 illustrated in FIG. 11 may be similar or identical to host computer 1030, one of base stations 1012a, 1012b, 1012c and one of UEs 1091, 1092 of FIG. 10, respectively. This is to say, the inner workings of these entities may be as shown in FIG. 11 and independently, the surrounding network topology may be that of FIG. 10.

In FIG. 11, OTT connection 1150 has been drawn abstractly to illustrate the communication between host computer 1110 and UE 1130 via base station 1120, without explicit reference to any intermediary devices and the precise routing of messages via these devices. Network infrastructure may determine the routing, which it may be configured to hide from UE 1130 or from the service provider operating host computer 1110, or both. While OTT connection 1150 is active, the network infrastructure may further take decisions by which it dynamically changes the routing (e.g., on the basis of load balancing consideration or reconfiguration of the network).

Wireless connection 1170 between UE 1130 and base station 1120 is in accordance with the teachings of the embodiments described throughout this disclosure. One or more of the various embodiments improve the performance of OTT services provided to UE 1130 using OTT connection 1150, in which wireless connection 1170 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1150 between host computer 1110 and UE 1130, in response to variations in the measurement results. The measurement procedure and/or the network functionality for reconfiguring OTT connection 1150 may be implemented in software 1111 and hardware 1115 of host computer 1110 or in software 1131 and hardware 1135 of UE 1130, or both. In embodiments, sensors (not shown) may be deployed in or in association with communication devices through which OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of OTT connection 1150 may include message format, retransmission settings, preferred routing etc.; the reconfiguring need not affect base station 1120, and it may be unknown or imperceptible to base station 1120. Such procedures and functionalities may be known and practiced in the art. In certain embodiments, measurements may involve proprietary UE signaling facilitating host computer 1110's measurements of throughput, propagation times, latency and the like. The measurements may be implemented in that software 1111 and 1131 causes messages to be transmitted, in particular empty or ‘dummy’ messages, using OTT connection 1150 while it monitors propagation times, errors etc.

The node 101 embodiments relate to FIG. 5, FIG. 7, FIG. 8 and FIGS. 10-15.

The node 101 may also be configured to communicate user data with a host application unit in a host computer 1110, e.g., via another link such as 1160.

The node 101 may comprise an interface unit to facilitate communications between the node 101 and other nodes or devices, e.g., the one or more wireless device 130, the wireless device 131, the network node 110, the host computer 1110, or any of the other nodes. In some particular examples, the interface may, for example, include a transceiver configured to transmit and receive radio signals over an air interface in accordance with a suitable standard.

The node 101 may comprise an arrangement as shown in FIG. 8 or in FIG. 11.

The wireless device 131 embodiments relate to FIG. 6, FIG. 7, FIG. 9 and FIGS. 10-15.

The wireless device 131 may also be configured to communicate user data with a host application unit in a host computer 1110, e.g., via another link such as 1160.

The wireless device 131 may comprise an interface unit to facilitate communications between the wireless device 131 and other nodes or devices, e.g., the node 101, the network node 110, the core network node 125, the another wireless device 132, any of the other one or more wireless devices 130, the host computer 1110, or any of the other nodes. In some particular examples, the interface may, for example, include a transceiver configured to transmit and receive radio signals over an air interface in accordance with a suitable standard.

The wireless device 131 may comprise an arrangement as shown in FIG. 9 or in FIG. 11.

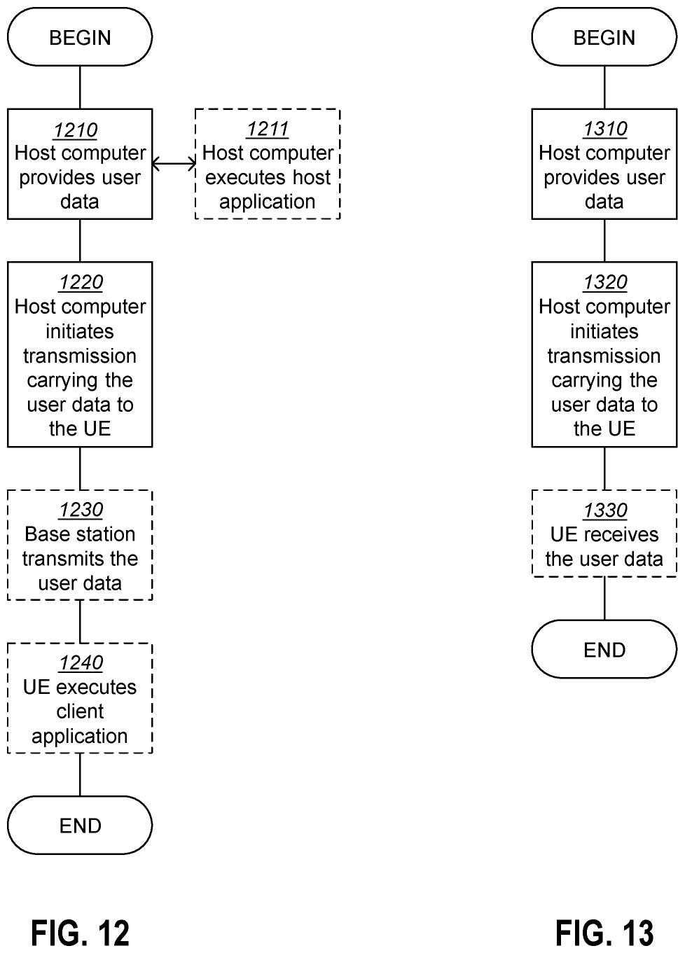

FIG. 12: Methods implemented in a communication system including a host computer, a base station and a user equipment in accordance with some embodiments

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 1210, the host computer provides user data. In substep 1211 (which may be optional) of step 1210, the host computer provides the user data by executing a host application. In step 1220, the host computer initiates a transmission carrying the user data to the UE. In step 1230 (which may be optional), the base station transmits to the UE the user data which was carried in the transmission that the host computer initiated, in accordance with the teachings of the embodiments described throughout this disclosure. In step 1240 (which may also be optional), the UE executes a client application associated with the host application executed by the host computer.

FIG. 13: Methods implemented in a communication system including a host computer, a base station and a user equipment in accordance with some embodiments

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 1310 of the method, the host computer provides user data. In an optional substep (not shown) the host computer provides the user data by executing a host application. In step 1320, the host computer initiates a transmission carrying the user data to the UE. The transmission may pass via the base station, in accordance with the teachings of the embodiments described throughout this disclosure. In step 1330 (which may be optional), the UE receives the user data carried in the transmission.

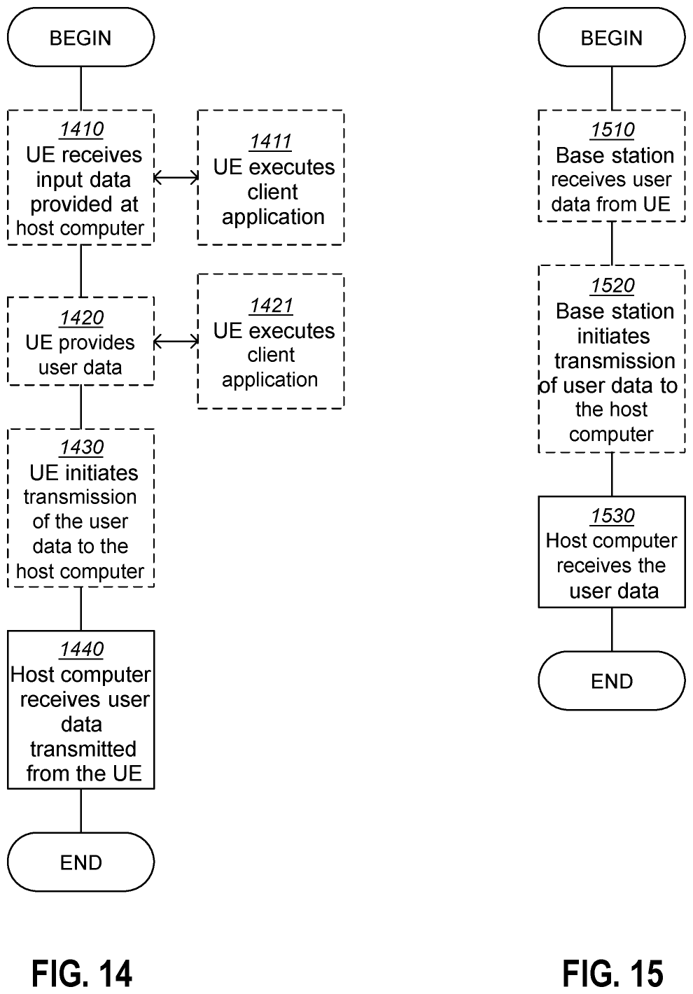

FIG. 14: Methods implemented in a communication system including a host computer, a base station and a user equipment in accordance with some embodiments

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1410 (which may be optional), the UE receives input data provided by the host computer. Additionally or alternatively, in step 1420, the UE provides user data. In substep 1421 (which may be optional) of step 1420, the UE provides the user data by executing a client application. In substep 1411 (which may be optional) of step 1410, the UE executes a client application which provides the user data in reaction to the received input data provided by the host computer. In providing the user data, the executed client application may further consider user input received from the user. Regardless of the specific manner in which the user data was provided, the UE initiates, in substep 1430 (which may be optional), transmission of the user data to the host computer. In step 1440 of the method, the host computer receives the user data transmitted from the UE, in accordance with the teachings of the embodiments described throughout this disclosure.

FIG. 15: Methods implemented in a communication system including a host computer, a base station and a user equipment in accordance with some embodiments

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1510 (which may be optional), in accordance with the teachings of the embodiments described throughout this disclosure, the base station receives user data from the UE. In step 1520 (which may be optional), the base station initiates transmission of the received user data to the host computer. In step 1530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 110.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the network node 110.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 110.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by any of the another wireless device 132, or any of the one or more wireless devices, e.g., the wireless device 131.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by any of the another wireless device 132, or any of the one or more wireless devices, e.g., the wireless device 131.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by any of the another wireless device 132, or any of the one or more wireless devices, e.g., the wireless device 131.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by any of the another wireless device 132, or any of the one or more wireless devices, e.g., the wireless device 131.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by any of the another wireless device 132, or any of the one or more wireless devices, e.g., the wireless device 131.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by any of the another wireless device 132, or any of the one or more wireless devices, e.g., the wireless device 131.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by any of the another wireless device 132, or any of the one or more wireless devices, e.g., the wireless device 131.

52. The method of embodiment 51, further comprising:
providing user data; and
forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by any of the another wireless device 132, or any of the one or more wireless devices, e.g., the wireless device 131.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the network node 110.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the network node 110.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by any of the another wireless device 132, or any of the one or more wireless devices, e.g., the wireless device 131.

76. The method of embodiment 75, further comprising:
at the base station, receiving the user data from the UE.

77. The method of embodiment 76, further comprising:
at the base station, initiating a transmission of the received user data to the host computer.

1.-40. (canceled)

41. A method performed by a node, the method being for handling signals, the node operating in a wireless communications network, and the method comprising:
determining a distribution of one or more wireless devices served by the node into a plurality of groups, wherein the determining is based on a division of resources available to the node into a corresponding plurality of groups, the resources comprising at least one of: code resources, frequency resources, and time resources, wherein the determined plurality of groups determines a corresponding plurality of sets of one or more signals to wake-up the one or more wireless devices, to be respectively monitored by the one or more wireless devices, and
initiating transmitting the corresponding plurality of sets of one or more signals to wake-up the one or more wireless devices, based on the determined distribution, to at least one of the wireless devices.

42. The method according to claim 41, further comprising:
sending a first indication towards the one or more wireless devices, the first indication enabling the one or more wireless devices to determine a respective group to which they belong, the respective group being based on the distribution of the one or more wireless devices served by the node into the plurality of groups, wherein the distribution is based on the division of resources available to the node into the corresponding plurality of groups, the resources comprising at least one of: code resources, frequency resources, and time resources, wherein the plurality of groups determines the corresponding plurality of sets of the one or more signals to wake-up the one or more wireless devices, to be respectively monitored by the one or more wireless devices.

43. The method according to claim 41, further comprising:
sending a second indication towards the at least one of the one or more wireless devices indicating the determined distribution to the at least one of the one or more wireless devices.

44. The method according to claim 42, wherein the sending is performed via at least one of: Radio Resource Control (RRC) signalling, System Information (SI), and non-access stratum (NAS) signalling.

45. The method according to claim 41, wherein the division comprises a first division of frequency resources, and wherein the determining is based on the following formula:
WURfrequencyResourceIndex=UE_ID mod N
wherein N is a number of groups in the plurality of groups, WURfrequencyResourceIndex is a configuration index of the frequency resources, and UE_ID is a respective identity of a respective wireless device.

46. The method according to claim 41, wherein the division comprises a first division of frequency resources, wherein every group of the plurality of groups corresponds to a respective set of frequency resources, and wherein a respective group for a respective wireless device is determined according to the following formula:
UE_group=UE_ID mod N
wherein N is a number of groups in the plurality of groups, and UE_ID is a respective identity of a respective wireless device.

47. The method according to claim 41, wherein the division comprises a second division of time resources, and wherein the determining is based on the following formula:
SFN mod(N)=UE_ID mod(N)
wherein N is a number of groups in the plurality of groups, SFN is a System Frame Number, and UE_ID is a respective identity of a respective wireless device.

48. The method according to claim 41, wherein the division comprises a second division of time resources, wherein every group of the plurality of groups corresponds to a respective set of time resources, and wherein a respective group for a respective wireless device is determined according to the following formula:
UE_group=UE_ID mod N
wherein N is a number of groups in the plurality of groups, and UE_ID is a respective identity of a respective wireless device.

49. The method according to claim 41, wherein every group of the plurality of groups corresponds to a respective set of time resources, and wherein the set of resources correspond to one of: a radio frame, a subframe, a slot and a symbol.

50. A method performed by a wireless device, the method being for handling signals, the wireless device operating in a wireless communications network, and the method comprising:
determining a respective group to which the wireless device belongs, the respective group being based on a distribution of one or more wireless devices served by a node operating in the wireless communications network into a plurality of groups, wherein the distribution is based on a division of resources available to the node into a corresponding plurality of groups, the resources comprising at least one of: code resources, frequency resources and time resources, wherein the determined plurality of groups determines a corresponding plurality of sets of one or more signals to wake-up the one or more wireless devices, to be respectively monitored by the one or more wireless devices, and
receiving the corresponding set of one or more signals to wake-up the wireless device, based on the determined respective group.

51. The method according to claim 50, further comprising:
obtaining a first indication from the node, the first indication enabling the wireless device to determine the respective group to which the wireless device belongs, the respective group being based on the distribution of the one or more wireless devices served by the node operating in the wireless communications network into the plurality of groups, wherein the distribution is based on the division of resources available to the node into the corresponding plurality of groups, the resources comprising at least one of: code resources, frequency resources and time resources, wherein the plurality of groups determines the corresponding plurality of sets of one or more signals to wake-up the one or more wireless devices, to be respectively monitored by the one or more wireless devices, and wherein the determining is based on the obtained first indication.

52. The method according to claim 50, further comprising:
obtaining a second indication indicating the distribution from the node, and wherein the determining is based on the obtained second indication.

53. The method according to claim 51, wherein the obtaining is performed via at least one of: Radio Resource Control (RRC) signalling, System Information (SI), and non-access stratum (NAS) signalling.

54. The method according to claim 50, wherein the division comprises a first division of frequency resources, and wherein the determining is based on the following formula:
WURfrequencyResourceIndex=UE_ID mod N
wherein N is a number of groups in the plurality of groups, WURfrequencyResourceIndex is a configuration index of the frequency resources, and UE_ID is a respective identity of a respective wireless device.

55. The method according to claim 50, wherein the division comprises a first division of frequency resources, wherein every group of the plurality of groups corresponds to a respective set of frequency resources, and wherein a respective group for a respective wireless device is determined according to the following formula:
UE_group=UE_ID mod N
wherein N is a number of groups in the plurality of groups, and UE_ID is a respective identity of a respective wireless device.

56. The method according to claim 50, wherein the division comprises a second division of time resources, and wherein the determining is based on the following formula:
SFN mod(N)=UE_ID mod(N)
wherein N is a number of groups in the plurality of groups, SFN is a System Frame Number, and UE_ID is a respective identity of a respective wireless device.

57. The method according to claim 50, wherein the division comprises a second division of time resources, wherein every group of the plurality of groups corresponds to a respective set of time resources, and wherein a respective group for a respective wireless device is determined according to the following formula:
UE_group=UE_ID mod N
wherein N is a number of groups in the plurality of groups, and UE_ID is a respective identity of a respective wireless device.

58. The method according to claim 50 wherein every group of the plurality of groups corresponds to a respective set of time resources, and wherein the set of resources correspond to one of: a radio frame, a subframe, a slot and a symbol.

59. A node, for handling signals, the node being configured to operate in a wireless communications network, and the node comprising:
radio circuitry; and
processing circuitry configured to:
determine a distribution of one or more wireless devices configured to be served by the node into a plurality of groups, wherein the determining is configured to be based on a division of resources configured to be available to the node into a corresponding plurality of groups, the resources being configured to comprise at least one of: code resources, frequency resources and time resources, wherein the determined plurality of groups is configured to determine a corresponding plurality of sets of one or more signals to wake-up the one or more wireless devices, to be respectively monitored by the one or more wireless devices, and
initiate transmitting the corresponding plurality of sets of one or more signals to wake-up the one or more wireless devices, based on the distribution configured to be determined, to at least one of the wireless devices.

60. A wireless device, for handling signals, the wireless device being configured to operate in a wireless communications network, and the wireless device comprising:
radio circuitry; and
processing circuitry configured to:
determine a respective group to which the wireless device belongs, the respective group being configured to be based on a distribution of one or more wireless devices configured to be served by a node configured to operate in the wireless communications network into a plurality of groups, wherein the distribution is configured to be based on a division of resources available to the node into a corresponding plurality of groups, the resources being configured to comprise at least one of: code resources, frequency resources and time resources, wherein the determined plurality of groups is configured to determine a corresponding plurality of sets of one or more signals to wake-up the one or more wireless devices, to be respectively monitored by the one or more wireless devices, and
receive the corresponding set of one or more signals to wake-up the wireless device, based on the respective group configured to be determined.
